(19) United States
(12) Patent Application Publication
(10) Pub. No.: US 2024/0396932 A1
(43) Pub. Date: Nov. 28, 2024

(54) METHOD AND SYSTEM FOR GENERATING APPLICATION-LAYER SIGNATURES CHARACTERIZING ADVANCED APPLICATION-LAYER ATTACKS

(71) Applicant: Radware Ltd., Tel Aviv (IL)

(72) Inventors: Ehud DORON, Moddi'in (IL); Alon TAMIR, Kiryat Ono (IL); David AVIV, Tel Aviv (IL)

(73) Assignee: Radware Ltd., Tel Aviv (IL)

(21) Appl. No.: 18/794,606

(22) Filed: Aug. 5, 2024

Related U.S. Application Data
(63) Continuation-in-part of application No. 18/176,667, filed on Mar. 1, 2023.
(60) Provisional application No. 63/477,522, filed on Dec. 28, 2022.

(51) Int. Cl. H04L 9/40

(52) U.S. Cl. CPC H04L 63/1458; H04L 63/1416

(57) ABSTRACT

A method and device for generating application-layer signatures characterizing advanced application-layer attacks are provided. The method includes computing, based on applicative peacetime baseline distributions and attack distributions of applicative attributes included in application-layer transactions directed to a protected entity, an attacker probability of an attacker executing an ongoing application-layer attack; comparing the attacker probability computed for each of the applicative attributes to a dynamic attacker probability threshold; and including in an application-layer signature eligible applicative attributes having an attacker probability higher than the dynamic attacker threshold, wherein the application-layer signature includes an inclusive section and an exclusive section, and wherein the application-layer signature is indicative of an ongoing attack based on one of the exclusive section and the inclusive section.

### CROSS-REFERENCE TO RELATED APPLICATIONS

This application is a continuation in part of U.S. patent application Ser. No. 18/176,667, filed on Mar. 1, 2023. The Ser. No. 18/176,667 Application claims the benefit of U.S. Provisional Application No. 63/477,522 filed on Dec. 28, 2022, the contents of which are hereby incorporated by reference.

### TECHNICAL FIELD

This present disclosure generally relates to techniques for characterization of application-layer denial of service (DoS) based attacks, and specifically for generating application-layer signatures characterizing advanced application-layer flood attack tools.

### BACKGROUND

These days, online businesses and organizations are vulnerable to malicious attacks. Recently, cyber-attacks have been committed using a wide arsenal of attack techniques and tools targeting both the information maintained by online businesses, their IT infrastructure, and the actual service availability. Hackers and attackers are constantly trying to improve their attack strategies to cause irrecoverable damage, overcome currently deployed protection mechanisms, and so on.

One type of popular cyber-attack is a Denial of Service (“DoS”)/Distributed Denial of Service (“DDoS”) attack, which is an attempt to make a computer or network resource unavailable or idle. A common technique for executing DoS/DDoS attacks includes saturating a target victim resource (e.g., a computer, a WEB server, an API server, a WEB application, other types of applicative servers, and the like), with a large quantity of external applicative requests or volume of traffic. As a result, the target victim becomes overloaded, and thus cannot assign resources and respond properly to legitimate traffic or legitimate service requests. When the attacker sends many applicative or other requests to its victim service or application, each victim resource will experience effects from the DoS attack. A DoS attack is performed by an attacker with a single machine, while a DDoS attack is performed by an attacker controlling many machines and other entities and directing them to attack as a group.

One type of DDoS attack is known as an “Application Layer DDoS Attack”. This is a form of a DDoS attack where attackers target application-layer processes, resources, or the applications as a whole. The attack over-exercises specific functions or features of an application to disable those functions or features, and by that makes the application irresponsive to legitimate requests or even terminate or crash. A major sub-class of application layer DDoS attack is the HTTP flood attack.

In HTTP flood attacks, attackers send many manipulated HTTP GET and/or POST and/or other unwanted HTTP requests to attack, or to overload, a victim server, service, or application resources. These attacks are often executed by an attack tool, or tools, designed to generate and send floods of “legitimate like” HTTP requests to the victim server. The contents of such requests might be randomized, or pseudo-randomized, in order to emulate legitimate WEB client behavior and evade anti-DoS mitigation elements. Examples of such tools include Challenge Collapsar (CC), Shaphyra, Mirai botnet, Meris botnet, Blood, MHDDoS, DDOSIA, Akira, Xerxes, WEB stresser, DDoSers, and the like.

Recently, a large number of new and sophisticated tools have been developed by hackers and are now being used in various lethal and very high-volume HTTP flood attacks. The need for very simple and accurate solutions for HTTP flood attack mitigation is becoming actual and urgent. Modern online services demand applicative anti-DoS solutions that are required to be able to characterize incoming HTTP requests as generated by attackers or by legitimate clients, all in real-time, with a very low false positive rate and a very low false negative rate. Attackers keep on improving their attack tools by generating “legitimate like” HTTP requests, resulting in very challenging mitigation and a need for a more specific characterization of applicative attacks.

Accurate characterization of HTTP flood attacks executed by such tools is a complex problem that cannot be achieved by currently available solutions for mitigating DDoS attacks. Distinguishing legitimate HTTP requests from malicious HTTP requests is a complex and convoluted task. The complexity of the problem results from the fact that there are dozens of attack tools that behave differently and generate different attack patterns. Further, the attack tools send HTTP requests with a truly legitimate structure (e.g., a header and payload as defined in the respective HTTP standard and following the industry's common practices) and with some parts of their requests' contents being sophisticatedly randomized.

For example, the values of HTTP headers, query argument keys and values, WEB Cookies, and so on, can all be randomly selected. Furthermore, since the multitude of HTTP requests is high (e.g., thousands or tens of thousands of requests in each second) and there is an ever-evolving content of requests, along with the vast usage of randomization, existing DDoS mitigation solutions cannot efficiently and accurately characterize HTTP flood application layer DDoS attacks. Existing detection solutions are based on calculating the normal baseline during peacetime (when no attack is active or detected), and under such models, any deviation from the baseline is detected as an attack. The baseline is a statistical model calculated or learned over received HTTP requests, representing a normal behavior of a legitimate client accessing the protected server. Upon HTTP flood attack detection, the normal baseline can potentially be used for the actual attacker characterization tasks.

There are major challenges with HTTP flood mitigation solutions that are based on legitimate normal baselining for the purposes of attack characterization. One challenge is due to the ability to realize an accurate baseline on a legitimate non-stationary application or an application with a low rate and bursty traffic. Complementarily, during an attack, it is challenging to realize fast and accurate learning of the attacker's behavior and understand the attacker patterns needed for generating an accurate and efficient application-layer signature. These challenges are substantial when it is needed to establish application-layer signatures when the attack is carried out by the attackers generating an ultra-high volume of random requests. In such cases, there is a relatively low probability that a specific attacker's pattern can be detected and mitigated.

Further, since HTTPS flood attacks employ legitimate-appearing requests with or without high volumes of traffic, and with numerous random patterns, it is difficult to differentiate such requests from valid legitimate traffic. Thus, such types of DDoS attacks are amongst the most advanced non-vulnerable security challenges facing WEB servers and application owners today.

Therefore, in order to accurately and efficiently characterize an applicative attack tool there is an essential need to compute a unique baseline that accurately models the legitimate behavior of the legitimate clients accessing a protected server or application. Further, such characterization is required to accurately distinguish between various types of legitimate requests (or transactions) and vast types of malicious requests during attack time. In all cases, the time to mitigate (“TTM”) should be in the order of seconds.

It would be, therefore, advantageous to provide an efficient security solution for baselining and characterization of HTTPS flood attacks.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include computing, based on applicative peacetime baseline distributions and attack distributions of applicative attributes included in application-layer transactions directed to a protected entity, an attacker probability of an attacker executing an ongoing application-layer attack. The method may also include comparing the attacker probability computed for each of the applicative attributes to a dynamic attacker probability threshold. The method may furthermore include including in an application-layer signature eligible applicative attributes having an attacker probability higher than the dynamic attacker threshold, where the application-layer signature includes an inclusive section and an exclusive section, and where the application-layer signature is indicative of an ongoing attack based on one of the exclusive section and the inclusive section. Other embodiments of this aspect include corresponding computer systems, apparatus, and computer programs recorded on one or more computer storage devices, each configured to perform the actions of the methods.

In one general aspect, a non-transitory computer-readable medium may include A non-transitory computer-readable medium storing a set of instructions for generating application-layer signatures characterizing advanced application-layer attacks, the set of instructions having: one or more instructions that, when executed by one or more processors of a device, cause the device to: compute, based on applicative peacetime baseline distributions and attack distributions of applicative attributes included in application-layer transactions directed to a protected entity, an attacker probability of an attacker executing an ongoing application-layer attack; compare the attacker probability computed for each of the applicative attributes to a dynamic attacker probability threshold; and include in an application-layer signature eligible applicative attributes having an attacker probability higher than the dynamic attacker threshold, where the application-layer signature includes an inclusive section and an exclusive section, and where the application-layer signature is indicative of an ongoing attack based on one of the exclusive section and the inclusive section. Other embodiments of this aspect include corresponding computer systems, apparatus, and computer programs recorded on one or more computer storage devices, each configured to perform the actions of the methods.

In one general aspect, a device is provided for generating application-layer signatures characterizing advanced application-layer attacks having: one or more processors configured to: compute, based on applicative peacetime baseline distributions and attack distributions of applicative attributes included in application-layer transactions directed to a protected entity, an attacker probability of an attacker executing an ongoing application-layer attack; compare the attacker probability computed for each of the applicative attributes to a dynamic attacker probability threshold; and include in an application-layer signature eligible applicative attributes having an attacker probability higher than the dynamic attacker threshold, where the application-layer signature includes an inclusive section and an exclusive section, and where the application-layer signature is indicative of an ongoing attack based on one of the exclusive section and the inclusive section. Other embodiments of this aspect include corresponding computer systems, apparatus, and computer programs recorded on one or more computer storage devices, each configured to perform the actions of the methods.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a schematic diagram utilized to describe the various embodiments for characterization application-layer flood attacks according to some embodiments.

FIG. 2A is a flowchart illustrating the characterization of HTTP flood attacks according to an embodiment.

FIG. 2B is a flowchart illustrating the creation of window paraphrase buffers according to an embodiment.

FIG. 3 is an example structure paraphrase vector generated according to an embodiment.

FIG. 4 is a flowchart illustrating the process of generating a paraphrase vector according to an embodiment.

FIG. 5 is an array of paraphrase buffers generated according to an embodiment.

FIG. 6 is a flowchart illustrating a process for generating application-layer signatures characterizing advanced application-layer flood attack tools according to an embodiment.

FIG. 7 is a chart demonstrating the transformation from histograms to paraphrase distributions.

FIG. 8 shows an example structure of an application-layer signature generated according to an embodiment.

FIG. 9 shows an example process for computing baseline probabilities according to an embodiment.

FIG. 10 shows an example process for computing attack probabilities according to an embodiment.

FIG. 11 shows a graph of a dynamic attacker threshold.

FIG. 12 is an example flowchart for a finetuning application-layer signatures according to an embodiment.

FIG. 13 is an example flowchart of a false negative process according to an embodiment.

FIG. 14 is an example flowchart of a false positive process according to an embodiment.

FIG. 15 is a block diagram of a device utilized to carry the disclosed embodiments.

### DETAILED DESCRIPTION

The embodiments disclosed herein are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural, and vice versa, with no loss of generality. In the drawings, like numerals refer to like parts through several views.

The various disclosed embodiments include a method for baselining and characterizing HTTP flood DDoS attacks. The disclosed method characterizes malicious requests over legitimate requests, to dynamically generate signatures of the attack tools. The generated signatures may allow efficient mitigation of HTTP flood attacks. In an embodiment, the disclosed method can be performed by a device in an out-of-path or an in-line always-on deployment. The various disclosed embodiments will be described with reference to an HTTP flood DDoS attack, but the techniques disclosed herein can be utilized to characterize flood DDoS attacks generated by other types of application layer protocols.

According to the disclosed embodiments, a signature of an attack tool is a subtraction of attack paraphrase distributions from baseline paraphrase distributions. Such distributions are determined or otherwise computed using paraphrase buffers. For the purpose of this disclosure and without limiting the scope of the disclosed embodiments, the following terms (either in their singular or plural form) are being utilized: a paraphrase; a paraphrase vector; a paraphrase buffer, which is a set of paraphrase values; paraphrase buffers, which are each a set of paraphrase buffers; baseline paraphrase distribution; baseline paraphrase distributions, which are each a set of baseline paraphrase distributions; attack paraphrase distribution; and attack paraphrase distributions, which are each a set of attack paraphrase distributions. A paraphrase characterizes the structure of a layer-7 transaction (e.g., HTTP request). That is, a paraphrase maintains the attributes of an incoming transaction. Each paraphrase includes one or more paraphrase values. A paraphrase vector includes a set of paraphrases. The paraphrases are used to generate the required applicative (Layer 7) signatures characterizing the attacker's applicative attributes for the purpose of attack mitigation.

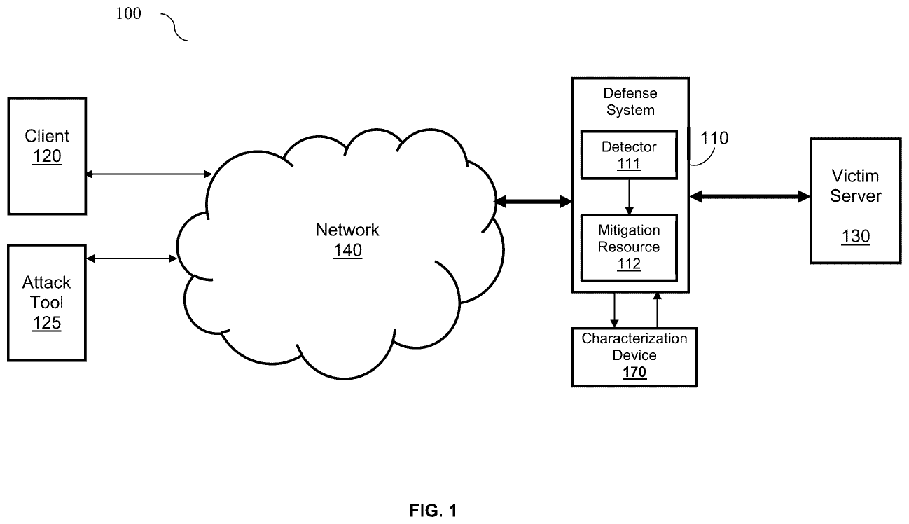

FIG. 1 is a schematic diagram 100 utilized to describe the various embodiments for the characterization and mitigation of HTTP flood attacks according to some embodiments. In schematic diagram 100, client devices 120 and 125 communicate with a victim server (or simply a server) 130 over a network 140. To demonstrate the disclosed embodiments, client device 120 is a legitimate client (operated by a real legitimate user, or other types of legitimate WEB client entities), a client device 125 is an attack tool (operated, for example, as a bot by a botnet), and the server 130 is a “victim server”, i.e., a protected server 130 under attack.

The legitimate client device 120 can be a WEB browser, or other type of legitimate WEB application client, user agent, or the like executing over a computing device, such as a server, a mobile device, an IoT device, a laptop, a PC, a connected device, a smart TV system and the like.

The attack tool 125 carries out malicious attacks against the victim server 130 and particularly carries out HTTP flood attacks. The attack tool 125 is used by an attacker to generate and send “legitimate-looking” HTTP requests toward the victim server. The attacker's generated HTTP requests have the correct structure and content as required by the HTTP protocol, and by these attributes the requests look “legitimate” even though they are malicious, as they were generated by an attacker with malicious purposes. In order to make the attack mitigation a very complex task, the attacker makes large use of randomization or pseudo-randomization. In some cases, the attacker generates a large set of distinct “legitimate” requests while randomly selecting the request to be transmitted. It should be noted that the attacker generates a large number of distinct HTTP requests to be able to evade fingerprinting and mitigation by simple WEB filtering or other means of attack mitigation.

The attack tool 125 may be an HTTP flood attack tool that can be deployed as a botnet using WEB proxies, or as an HTTP flood attack tool without using WEB proxies. The attack tool 125 also can be deployed as a WEB stresser, DDoSers, and other “DDoS for hire” forms of attacks.

The attack tool 125 generates requests with a legitimate structure and content. To obtain the “legitimate structure,” attacker-generated HTTP requests may include a legitimate URL within the protected application, a set of standard and non-standard HTTP headers, WEB Cookie, and contain one, or more, query arguments. The attack tool 125 can constantly include a specific HTTP header, or query arguments, in its generated HTTP requests or randomly decide to include them or not in each request or set of requests generated. The attack tool can also randomly select the attacked URL to be addressed in each of the requests it generates.

The attack tool 125 generated requests can also contain legitimate and varied content, or values. To make its generated requests “look” legitimate, the attack tool generated HTTP requests can have HTTP headers with legitimate values (e.g., a UserAgent can be randomly selected from a predefined list of legitimate UserAgents, References can be randomly selected from a predefined list of legitimate and common WEB sites, e.g., facebook.com, google.com).

These overall operations of the attack tool 125 result in a set of tens of thousands, or even millions, of the attacker's distinct HTTP requests that can be potentially sent to the victim server 130. The attacker uses randomization to select the actual HTTP request to send toward its victim in each request transmission. Therefore, aiming to simply, or manually, recognize the millions of distinct attacker's requests “as is” by human operation teams would be a very tedious task, and almost an impossible one. It is important to note that these tools have numerous mutations and variants, but still follow similar operations, and the HTTP requests they generate are as described above. Advanced attack tools are designed to bypass simple Layer-7 filtering for mitigation by generating a large set of distinct and “legitimate-looking” HTTP requests. As such, no dominant or frequent set of several HTTP requests can be characterized as issued by the attack tool 125.

Requests generated by the legitimate client(s) are more diverse in their structure compared to the attacker's requests. The legitimate client HTTP requests potentially have more HTTP headers, standard and non-standard headers, turn to a plurality of URLs within the protected entity, which may include the victim server 130, have more key-values pairs in Cookie, use more query arguments, and similar. Based on the higher diversity and content distribution of legitimate requests, the legitimate traffic applicative normal baseline is calculated, and the accurate learning of legitimate requests' behavior is possible.

It should be noted that the embodiments disclosed herein are applicable when multiple attack tools execute the attacks against the victim server 130 concurrently. The multiple attack tools can be the same tool or a couple of different tools attacking simultaneously and not necessarily with similar traffic volumes. Similarly, a vast number of legitimate client devices 120 can operate concurrently to be delivered with the services proposed by server 130. Both client devices 120 and 125 can reach the victim server 130 concurrently. The network 140 may be but is not limited to, a local area network (LAN), a wide area network (WAN), the Internet, a public or private cloud network, a cellular network, and a metropolitan area network (MAN), wireless network, IoT network, a corporate network, a datacenter network or any combination thereof.

According to the disclosed embodiments, a defense system 110 (hereinafter “the system 110”) is deployed between client device 120, attack tool 125, and victim server 130. The system 110 is connected to a characterization device 170 (hereinafter “the device 170”) configured to carry out part of the disclosed embodiments. Specifically, during peacetime, the device 170 is configured to analyze requests received from the system 110 and learn the legitimate traffic applicative baselines. During an attack the device 170 uses the calculated applicative baselines to build a dynamic applicative signature, or signatures, characterizing the attack tool 125 (or the attacker) HTTP requests. The signature generated by device 170 may allow a mitigation action or policy selection. The mitigation action may be carried out by system 110. In another embodiment, the mitigation actions are realized in the device 170.

An indication of an ongoing attack is provided to the device 170 by the system 110. The techniques for the detection of ongoing attacks are outside of the scope of the disclosed embodiments. Example techniques for detection of an ongoing layer-7 DDoS attacks can be found in U.S. patent application Ser. No. 18/058,482, titled TECHNIQUES FOR DETECTING ADVANCED APPLICATION LAYER FLOOD ATTACK TOOLS, assigned to the common assignee, and hereby incorporated for that which it contains.

The system 110 may be deployed in an in-line or an always-on mode, or in other types of deployments that allow peacetime baselining of incoming applicative transactions.

The system 110, device 170, and the victim server 130 may be deployed in a cloud computing platform and/or in an on-premises deployment, such that they collocate together or in a combination. The cloud computing platform may be, but is not limited to, a public cloud, a private cloud, or a hybrid cloud. Examples of cloud computing platforms include Amazon® Web Services (AWS), Cisco® Metacloud, Microsoft® Azure®, Google® Cloud Platform, and the like. In an embodiment, when installed in the cloud, the device 170 may operate as a SaaS or as a managed security service provisioned as a cloud service. In one embodiment, when installed on-premise, the device 170 may operate as a managed security service.

In an example configuration, the system 110 includes a detector 111 and a mitigation resource 112. The detector 111 in the system 110 is configured to provide an indication of an ongoing attack. The mitigation resource 112 is configured to perform one or more mitigation actions triggered by the detector 111, to mitigate a detected attack. The mitigation resource may be but is not limited to, a scrubbing center or a DDoS mitigation device. In an embodiment, the system 110 and/or the device 170, are integrated into a DDoS mitigation device. In another embodiment, the system 110 and/or the device 170 is a multi-tiered mitigation system. The arrangement, configuration, and orchestration of a multi-tiered mitigation system are disclosed in U.S. Pat. No. 9,769,201, assigned to the common assignee, which is hereby incorporated by reference.

In an embodiment, the system 110 and/or the device 170, are integrated in a WAF (Web Application Firewall) device. In yet another embodiment, the system 110 and/or the device 170, are integrated together in any form of a WEB proxy or a WEB server. In yet another embodiment, the system 110 and/or the device 170 can be integrated into WEB caching systems like CDN and others.

The victim server 130 is the entity to be protected from malicious threats. The server 130 may be a physical or virtual entity (e.g., a virtual machine, a software container, a serverless function, and the like). The victim server 130 may be a WEB server (e.g., a server under attack, an online WEB server under attack, a WEB application under attack, an API server, a mobile application, and so on).

According to the disclosed embodiments, throughout peacetime and during an active attack, device 170 is configured to inspect applicative transactions received from the system 110. The transactions are applicative requests, such as HTTP requests sent to the victim server 130 by both legitimate client device 120 and attack tool 125. The transactions are received at the device 170 during peacetime for the purpose of learning and baselining the normal applicative behaviors needed for the attack characterization, and applicative signature generation, all for the purpose of accurate and efficient attack mitigation. Upon detection of an active attack by the detector 111, the device 170 continues to receive the incoming transactions throughout the entire attack duration. During an active attack, the device 170 is configured to analyze the received transactions and determine if an HTTP request's structure is of the attack tool (125) executing the detected attack, or a legitimate HTTP request sent by client device 120. The device 170 reports its decision on each of the received requests to the system 110. The decision can be to mitigate the request or to safely pass the requests to the victim server 130.

In yet another embodiment, and in order to improve the efficiency and cost structure of the device 170, the device 170 is fed and updated by samples of the incoming HTTP transactions. The sampling can be for 1 in N received transactions, the first received N transactions in a time window, and similar. In yet another embodiment, the sampling rate N can be different for peacetime conditions and attack time conditions, to better adjust to the number of HTTP requests transmitted toward the protected entity.

In another embodiment, to enhance attack mitigation at a lower cost, the number of samples sent to device 170 may be restricted to a set limit of samples per second. This limit can vary between regular and attack conditions, allowing for a larger number of samples to be sent to device 170 during an active attack. Moreover, the quantity of samples per second sent to device 170 during an attack is also dependent on the attack volume, enabling the dynamic adjustment of the sample rate to higher attack traffic volumes, or RPS.

For improving efficiency and cost, other embodiments can be suggested. Here, during an active attack, the device 170 is only responsible for dynamically building the required accurate signature. Complementarily, the system 110 is responsible for the actual, per transaction, mitigation activities. The device 170 is configured to pass continuously the signature to the system 110, which uses the signature for the actual attack mitigation. During an active attack the system 110 is configured to analyze each incoming request, compare the request to the signature provided by the device 170, and decide, on a per transaction basis, whether the transaction was generated by the client device 120, i.e., the transaction is legitimate and should be passed safely, or that the transaction was generated by the attack tool 125, i.e., the transaction is an attack and should be mitigated. In such an embodiment, the device 170 uses the incoming traffic samples to dynamically build the accurate signature. It should be noted that the device 170 can function by analyzing all transactions without any sampling (peacetime and attack time).

Specifically, the system 110 is configured to sample the incoming traffic, i.e., HTTP requests, and realize attack mitigation using the generated signatures. Specifically, a signature of an attack tool can be generated, modified, or updated every time window. A time window is a preconfigured time period, e.g., 5 seconds or 10 seconds. Three (3) paraphrase buffers can be updated during each time window: window, baseline, and attack. A window paraphrase buffer is provided at each time window, a baseline paraphrase buffer is updated during peacetime (no active attack) each time window, and attack paraphrase buffers are provided during the attack at each time window. In other embodiments, only window and attack paraphrase buffers are maintained.

For each of the abovementioned paraphrase buffers, there are two types of paraphrase buffers: Static and dynamic. Each paraphrase has a single “paraphrase buffer” containing all potential “paraphrase values”. Static paraphrases have pre-allocated buffers, while dynamic paraphrases only have a dynamically allocated buffer for the top predefined number of most frequent paraphrases. A paraphrase buffer can be treated as a histogram that shows the occurrences of paraphrase values over a specific time interval.

The device 170 is configured to identify the paraphrase values demonstrated by the incoming requests sent by the attack tool 125 and legitimate clients 120, and to distinguish between them. To this end, the device 170 is configured to compare between the application's normal, peacetime, paraphrase behavior, and attack time paraphrase behavior. This is realized by the comparison of peacetime paraphrase distributions with attack time paraphrase distributions. The signatures generated by the device 170 can be configured at the mitigation resource 112 to allow effective mitigation of the attack. That is, effective mitigation is performed by safely transferring the legitimate traffic to the protected server 130 and taking the required mitigation action on the attacker's malicious traffic based on the generated signatures.

In an example embodiment, a mitigation action may be performed, by the mitigation resource 112, selectively on the attacker traffic only. Mitigation actions can be a simple blocking of the request, a response on behalf of the server 130 with a dedicated blocking page, or similar. In yet another embodiment, the mitigation action may include limiting the rate of attacker traffic or merely reporting and logging the mitigation results without any actual blocking of the incoming request. In another embodiment, the mitigation action can be issuing various types of challenges, e.g., CAPTCHA, to better identify the client as coming from a legitimate user or an attack tool operated as a bot. Further, the generated signatures can be utilized to update a mitigation policy defined in the mitigation resource 112.

In the example deployment, shown in FIG. 1, the system 110 is connected in line with the traffic between the client device 120 and the attack tool 125 toward the victim server 130. In this deployment, the system 110 is configured to sample and process ingress traffic from the client device 120 and the attack tool 125.

In some configurations, the system 110 is also connected out-of-traffic where traffic is diverted by a switch/router, a WEB proxy (not shown), or by the protected server, to processing by the system 110. In such configurations, the device 170 is also connected out-of-path.

In yet another configuration, the system 110 may be always-on deployment. In such a deployment, the system 110 and the device 170 can be part of a cloud protection platform (not shown).

In another embodiment, the device 170 is integrated with the system 110. In such an embodiment, the processing of requests by the device 170 is performed at both peacetime and at the time of the attack, regardless of the deployment of the integrated system. This integrated system can be a DDoS mitigation device, a Web Application Firewall, and the like.

In yet another deployment, the detector 111 can be deployed independently outside of the system 110, and can communicate with both defense system 110 and device 170. In another embodiment, the device 170 can be integrated with the detector 111, and this integrated system can communicate with system 110 in such a way that it may receive traffic samples in various rates and ratios and provide back to system 110 the attack life cycle indications, e.g., attack start and attack termination, and the dynamic accurate signature. The system 110 uses this information to enforce the attack mitigation.

It should be noted that although one client device 120, one attack tool 125, and one victim server 130 are depicted in FIG. 1 merely for the sake of simplicity, the embodiments disclosed herein can be applied to a plurality of clients and servers. The clients may be located in different geographical locations. The servers may be part of one or more data centers, server frames, private clouds, public clouds, hybrid clouds, or combinations thereof. In some configurations, the victim server 130 may be deployed in a data center, a cloud computing platform, on-premises of an organization, and the like. The cloud computing platform may be a private cloud, a public cloud, a hybrid cloud, or any combination thereof. In addition, the deployment shown in FIG. 1 may include a content delivery network (CDN) connected between client device 120, attack tool 125, and server 130.

System 110 and device 170 may be realized in software, hardware, or any combination thereof. System 110 and device 170 may be a physical entity (an example block diagram is discussed below) or a virtual entity (e.g., virtual machine, software container, micro entity, function, and the like).

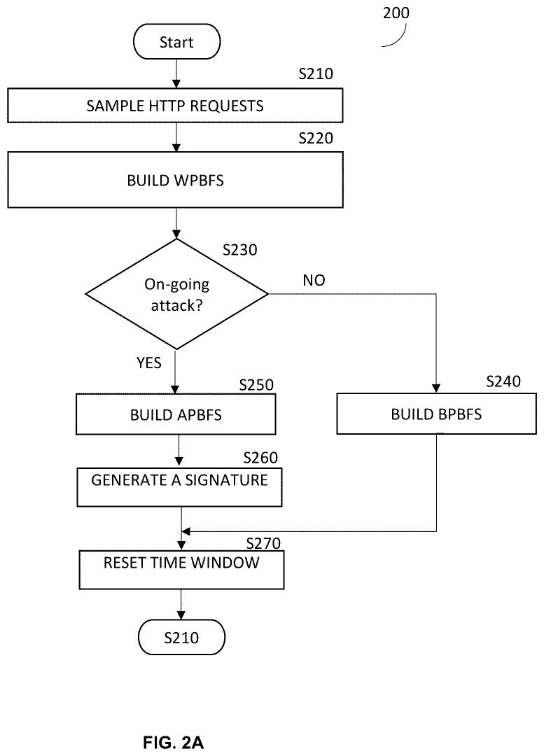

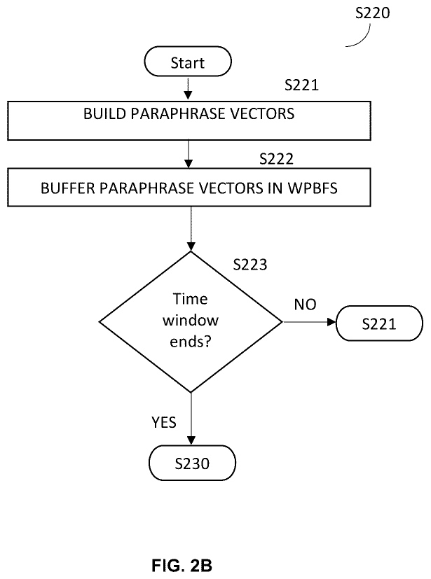

FIG. 2A shows an example flowchart 200 illustrating the characterization of HTTP flood attacks for the purpose of dynamically generating application-layer accurate attack signatures based on an applicative normal baseline learned during peacetime, according to an embodiment. During an active attack, the method is designed to characterize requests generated by attackers using HTTP flood tools (from at least one type of tool), such as, for example, those mentioned above, and to distinguish the legitimate requests from the attackers' requests.

The characterization is based on distinguishing the structure of legitimate HTTP requests from the structure of malicious requests based on the legitimate traffic applicative baseline structure learned during peacetime. The signature generation process discussed herein is adaptive and capable of learning a vast number of different attack tools, each such tool can generate the attack on its own or cooperate with other tools to build the attack. A new signature may be generated at the end of every time window. As such, the method presented in FIG. 2A operates at each time window. It should be emphasized that the new signatures are generated or updated only during an active attack time; correspondingly, the application's legitimate behavior at normal baseline is learned only during peacetime. It should be noted that a signature is an application-layer accurate and efficient signature of an attack tool(s) such as those mentioned above. The generated signature can be utilized by mitigation resources, such as 112 in FIG. 1, to efficiently enforce a mitigation action. That is, a mitigation resource may check for a match of each incoming request to the generated signature and based on the match, a mitigation action may be applied. For simplicity, we will refer to a dynamically generated application-layer signature as a “signature.”

It should be noted that the signature is adaptive in a sense that it is dynamically updated to meet changes in attack traffic patterns that can be caused when an attacker adds or removes one or more tools from being part of the attack (by activating or deactivating a number of attack tools 125).

At S210, HTTP requests directed to a protected object (e.g., server 130, FIG. 1) are sampled. The requests are sampled and processed during a time window regardless of if there is an ongoing DDoS attack. Alternatively, S210 may include receiving samples of the requests, at various rates. In yet another embodiment, S210 may include receiving and analyzing all the transactions without any sampling.

At S220, window paraphrase buffers (WPBFs) are built for a current time window. At peacetime and at attack time, the WPBFs represent the current window paraphrases' behavior. In an embodiment, S220 includes vectoring the HTTP requests, sampled or not, into paraphrase vectors and updating the window paraphrase buffers using their respective paraphrase values. In one embodiment, the WPBFs provide a histogram of the structure of requests received during the current time window. In another embodiment, the WPBFs provide distributions of the structure of requests received during the current time window. The duration of a time window is predetermined, e.g., 5 seconds, 10 seconds, and the like, and can be different for peacetime and attack-time. The operation of S220 is discussed in more detail with reference to FIG. 2B.

Referring now to FIG. 2B, at S221, the incoming request is processed and placed in, or represented as a respective paraphrase vector. The characterization and signature generation are based on an understanding of the structure of the requests and not the contents of the request. Such a structure representation is referred to here as a paraphrase. A paraphrase vector is a data structure representing attributes of incoming HTTP requests' structure according to a notation of a paraphrase.

In an example embodiment, the following HTTP request attributes are included in a “paraphrase vector” of HTTP request as a statically defined paraphrases: HTTP VERB (GET, POST, PUT, and such); a number of path elements in the request URL path; a number of query arguments in the request URL; a number of key:values cookie elements in cookie; a length of User-Agent header value; the User Agent actual value; the total length in bytes of the request; a total number of “known HTTP headers” (standard HTTP headers); and a total number of “unknown headers”, i.e., all HTTP headers that are not standard HTTP headers according to any existing standards or alternatively defined standards. The existence, or non-existence, of a predefined set of HTTP headers (like host header, sec* headers, accept* headers, and such) are also included as paraphrases in the system paraphrase vector. This set of specific HTTP headers can be composed of standard or non-standard HTTP headers. In yet another embodiment, the paraphrase vector entities are learned dynamically, to be adaptive to the incoming traffic of a specific application. Other HTTP request attributes acting as paraphrases include the HTTP protocol Version used to issue the request (like HTTP1.0, HTTP1.1, HTTP2.0, and similar), and the geographical location (GEO) of the client 120 or attack tool 125 who generates the request, the GEO being defined as accruing to the client or attack tool source IP address. The resolution of GEO identity from source IP is done according to existing IP intelligence services like MaxMind and similar.

In yet another embodiment, and in order to adapt to various types of protected applications, the actual HTTP request attributes are considered a paraphrase and are included in a paraphrase vector, can be defined dynamically, learned over time, and so on. In yet another embodiment, the paraphrase vector entities are dynamically defined by the user operating the system to be adaptive to the protected application's operational needs or other needs.

Alongside the above static set of paraphrases, a dynamically defined set of paraphrases is defined. The dynamic paraphrases are dynamic in a sense that they are not predefined, but rather are dynamically learned to meet the legitimate client 120 application's attributes and the attributes of the various attack tools 125. In an embodiment, the definition of standard headers or non-standard headers can be defined dynamically. Other attributes (paraphrases) that can be defined dynamically are the existence, or non-existence, of all HTTP Headers Key, Query Argument Key, and Cookies in Cookie Key. For an example, query argument “page=23” is dynamically defined as the paraphrase “query is page exists”. Similar to the static exists/not-exists type of paraphrase, the dynamic paraphrases represent the key name only and not the value. In an additional embodiment, the actual value also represents the dynamic paraphrase, i.e., query argument “page=23” is dynamically defined as paraphrase “query is page=23 exists”.

Another type of dynamically defined paraphrase is obtained by selecting a single value for a multiple-value paraphrase (e.g. HTTP method, number of known or unknown headers, HTTP header length and similar). The selected single value can then be treated as an exists or not-exists type of dynamic paraphrase (or a “binary paraphrase”). For example, a single paraphrase value from multiple paraphrase values may include the following examples: “HTTP Method is GET”, or for the GEO paraphrase can be set as “GEO is US”. An accurate selection of such a single value from multiple value paraphrase can improve the generated signature quality in terms of false positives and false negatives.

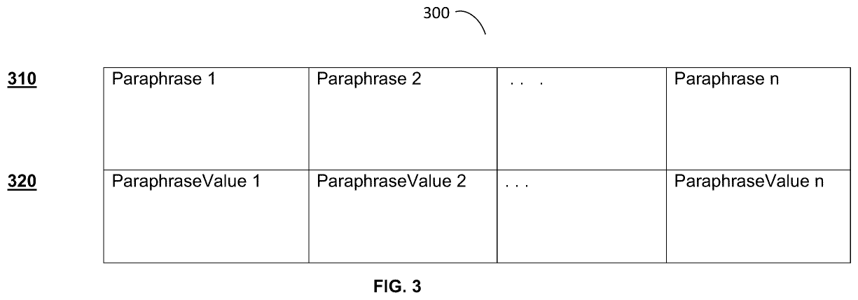

An example paraphrase vector 300 is shown in FIG. 3, where row 320 represents the paraphrase values of the respective paraphrase (attribute) in row 310. The paraphrase value can be either an integer number (e.g., number of cookie elements in the Cookie HTTP header, request size ranges), string (e.g., HTTP method type), or a binary (“exists” or “does not exist” for a static or dynamic binary paraphrase).

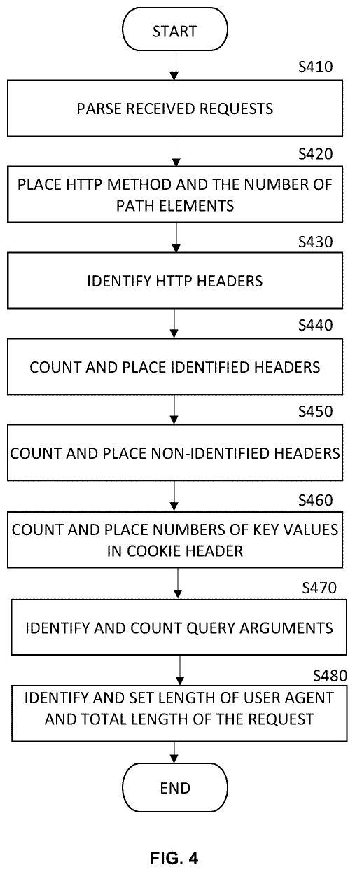

The conversion or placing of values from the received HTTP request in the paraphrase vector depends on the respective attributes. A process for generating a paraphrase vector is further discussed with reference to FIG. 4.

As the paraphrases represent the HTTP request structure, and there is a substantial difference between attacker and legitimate client request structures, it is assumed that the paraphrase vector of received HTTP requests should be used for attacker characterization in reference to the normal legitimate client applicative baseline structure behavior. Requests sent by attackers, or attackers' various attack tools, can be represented using a relatively small number of paraphrases and, hence, paraphrase vectors. That is, the paraphrase vector represents the structure of a request. However, multiple different requests can share the same paraphrase, as the actual content of a request is not part of its paraphrase vector. It should be appreciated that using this approach, a large number (e.g., tens, thousands, or millions) of attacker-distinct HTTP requests are represented as a small set of paraphrases. This small set represents the HTTP requests generated by the attacker, or attackers, (e.g., attack tool 125, FIG. 1), and not by most of the legitimate clients as their paraphrase vectors are much more diverse, not repetitive, and higher in their count. The attacker traffic is represented as a set of paraphrases, and their differences from the legitimate paraphrases behavior are the foundation of building the applicative signature. Using a dynamically defined paraphrases enhances the ability to better characterize the unique behavior of legitimate clients' applications (e.g. application specific cookies keys) and differentiate it from the unique behavior of attackers' tools.

Referring now to FIG. 2B, at S222 the paraphrase vectors, corresponding to the incoming sampled (or not sampled) HTTP requests, are buffered into an array of paraphrase buffers to provide the WPBFs. The WPBFs can be referred to as a set of paraphrase buffers representing the current window paraphrase behavior. The array is a data structure that maintains the overall occurrences of each paraphrase value, for each static and dynamic paraphrase, over the incoming traffic during the current time window for peacetime and also during an active attack for attack time windows. The array contains the same static and dynamic paraphrases as defined for a paraphrase vector (e.g., HTTP VERB, number of path elements in the request URL path, and exists/not exists headers), such that each paraphrase has its own dedicated paraphrase buffer.

A paraphrase buffer is a data structure constructed to include values of a single paraphrase. For each possible paraphrase value, the buffer has the actual “value” field along with an “occurrences” field. The occurrences represent the total aggregated number of HTTP requests with the specific value that appeared for the specific paraphrase. For each protected entity (e.g., victim server 130, FIG. 1), a single dedicated WPBFs array is maintained.

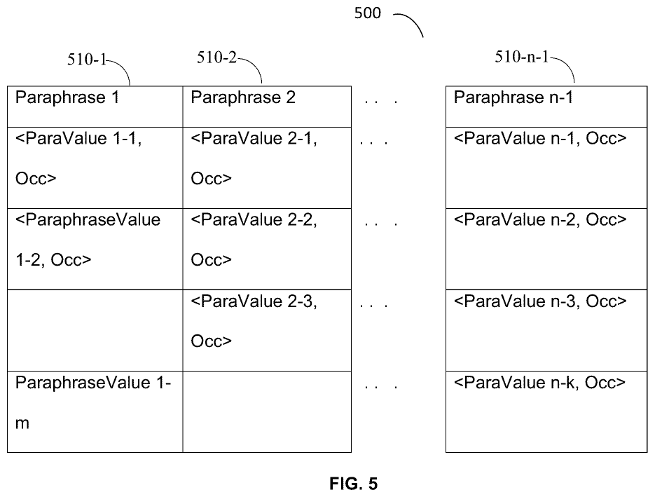

An example array 500 of paraphrase buffers is shown in FIG. 5. The array 500 includes a list of paraphrase buffers 510-1, 5. Each buffer holds a list of respective paraphrase values and the number of occurrences counted for the same value. Each paraphrase can have a different number of paraphrase values. As an example, if the incoming vectors are aggerated (representing 10 different HTTP requests), and there are 5 vectors with the GET method, 4 vectors with the POST method, and 1 vector with the HEAD method, the number of occurrences for the paraphrase values GET, POST, and HEAD would be 5, 4, and 1 respectively. In an example embodiment, the possible paraphrase values are predefined for each type of paraphrase.

In an embodiment, for dynamic paraphrases (headers keys, cookies in cookie, query arguments, and the like), their paraphrase buffers are dynamically allocated. In order to avoid resource allocation starvation in the characterization device 170, for the case where a large number of dynamic paraphrases appear at the incoming traffic (especially for an attack launched using compositions of tools where each tool uses a high degree of randomization), special care is taken. A paraphrase buffer is allocated only for a pre-defined number of dynamic paraphrases (e.g. 500) and only for the most frequent values that appeared during the collection window. Dynamic paraphrases that “appeared only once” are not counted.

In an embodiment, the array 500 can serve for window paraphrase buffers WPBFs, attack paraphrase buffers APBFs, and baseline paraphrase buffers BPBFs.

Referring back to FIG. 2B, in an embodiment, S222 includes updating the respective paraphrase buffer in the array with each sampled HTTP request. In this embodiment, the vector generated or updated in response to a received HTTP request, with or without sampling, is parsed and scanned, and an occurrence count in the paraphrase buffer is incremented by one for each corresponding paraphrase value in the scanned vector. At the beginning of each time window, the occurrences count is set to zero; for a first-seen paraphrase value, the occurrences count is set to one.

In one embodiment, the WPBFs provide a histogram of the paraphrase buffers of a current time window. In another embodiment, the WPBFs provide distributions of the paraphrase buffers of a current time window.

Returning to FIG. 2B, at S223, it is checked if the time window has elapsed, and if so, execution continues with S230 (FIG. 2A); otherwise, execution returns to S221, where the building of the WPBFs continues. In some embodiments, it is checked if the number of requests being processed is over a predefined threshold. In this case, all occurrence values in all paraphrase buffers are multiplied by, for example, a factor of 0.5 or another predefined number smaller than 1, such that warp-around is avoided. In an embodiment, the time window can be statically defined, such as a 10-second window or a 5-minute window; in a different embodiment the time window can be dynamically defined.

Returning to FIG. 2A, at S230, it is checked if an attack indication has been received during the time window or beforehand. Such an indication may be received from a detection system (e.g., system 110, FIG. 1). If an attack indication has not been received, execution continues with S240; otherwise, execution continues with S250.

At S240, baseline paraphrase buffers (BPBFs) are built based on the WPBFs. The BPBFs represent the paraphrase peacetime normal applicative behavior, or the legitimate paraphrase behavior. In an embodiment, S240 may include updating BPBFs with paraphrase value occurrences aggregated in the WPBFs from the latest (preceding) time window.

In an embodiment, WPBFs provide the distributions of the paraphrase buffers of a current time window. According to this embodiment, building the BPBFs includes applying Alpha (IIR) filters that average the distributions of a current time window into BPBFs such that the overall average over the past time is built. In other embodiments, other averaging methods, like FIR filters, are being used.

Then, execution continues with S270, where all occurrences' values in the WPBFs are cleared, and a new time window starts. Then execution returns to S210 for processing a new time window. It should be noted that the structure of the BPBFs is the same as the WPBFs buffers. It should be further noted that BPBFs are updated at the end of any time window if no attack indication is received.

In an embodiment, during peacetime at the end of each time window, updating the BPBFs with values aggregated in the WPBFs is realized using an Alpha filter to compute a paraphrase value mean occurrences of paraphrase values in the BPBFs for the current time window. In an embodiment, the paraphrase values mean occurrences are computed as follows:

$${ParaValueOccMean}_{i , j} [ n + 1 ] = {ParaValueOccMean}_{i , j} [ n ] \cdot ( 1 - α ) + {WinParaValueOcc}_{i , j} [ n + 1 ] \cdot α \qquad Equ . 1$$

where, ParaValueOccMean_{i,j}[n] is the average occurrence for paraphrase value i, belongs to paraphrase j, for time window n. The WinParaValueOcc_{i,j}[n+1] is the total window occurrences for paraphrase value i, belongs to paraphrase j, as calculated in time window n+1. The α is the alpha coefficient, which defines an Alpha filter “integration” period. The “integration period” refers to the length of time that it takes to integrate. The integration period is the time on the averaging performed by the Alpha filter. In an example embodiment, the Alpha coefficient is selected as 0.001 to enable an approximation of a five-hour integration period.

In another embodiment, the WPBFs provide distributions of the paraphrase buffers of a current time window. At the end of each time window, the occurrence values aggregated in the WPBFs are used to calculate the probability distribution function of a just-ended past window. In an embodiment, the “Window Paraphrase Distribution”, or the WindowParaValueProbi,j[n], is calculated as follows:

$${WinParaValueProb}_{i , j} [ n ] = \frac{{ParaValueWinOcc}_{i , j} [ n ]}{{\sum }_{k} {ParaValueWinOcc}_{k , j} [ n ]} \qquad Equ . 2$$

Where WinParaValueProb_{i,j}[n] is the probability of appearance of Paraphrase Value i, belongs to Paraphrase j, for time window n. The ParaValueWinOcc_{i,j}[n] represents the last time window occurrences for Paraphrase Value i, belongs to Paraphrase j, for time window n, as taken from “Window Paraphrase Buffer”. In this embodiment the BPBFS represents the baseline distribution of each paraphrase, or the Baseline Paraphrase Distribution. Here the baseline distribution is calculated as the ParaValueProbMean[n+1] as follows:

$${BaselineParaValueProb}_{i , j} [ n + 1 ] = {BaselineParaValueProb}_{i , j} [ n ] \cdot ( 1 - α ) + {WinParaValueProb}_{i , j} [ n + 1 ] \cdot α \qquad Equ . 3$$

where ParaValueProbBaseline_{i,j}[n] is the average baseline probability for Paraphrase Value i, belongs to Paraphrase j, for time window n. The WinParaValueProb_{i,j}[n]
is the window probability for Paraphrase Value i and belongs to Paraphrase j, as calculated in time window n. The parameter α is the alpha coefficient, which defines the filter “integration” period. In an example embodiment, the alpha coefficient is tuned to allow 5 hours of integration. This process is discussed in more detail below.

Example embodiments for learning the baselines are disclosed in U.S. patent application Ser. No. 18/398,985, titled TECHNIQUES FOR ACCURATE LEARNING OF BASELINES FOR CHARACTERIZING ADVANCED APPLICATION-LAYER FLOOD ATTACK TOOLS, assigned to the common assignee, and hereby incorporated for that which it contains.

At S250, when there is an ongoing attack, attack paraphrase buffers (APBFs) are built. The APBFs represent the paraphrase attack time behavior over the time windows, starting from the first window where the attack was detected and throughout an active ongoing attack. During an ongoing attack, the APBFs are updated with paraphrase value occurrences aggregated in the WPBFs from the latest time window. This is performed for each time window during the indication of an ongoing attack. It should be noted that updating the APBFs does not require updating the BPBFs, and thus the contents of the BPBFs remain the same during attack time.

In an embodiment, during an active attack, at the end of each time window, the APBFs are updated with values aggregated in the WPBFs using a simple summation of current window occurrences to the attack aggregated summation. In an embodiment, the time window defined for the attack time behavior calculation is different than the time window for peacetime calculation.

In yet another embodiment, a generated signature can be rapidly adapted to the attacker requests' structure. To this end, during an active attack, at the end of each time window, the APBFs are updated with values aggregated in the WPBFs using an Alpha Filter with a short integration period. The update is made such that the paraphrase values mean occurrences in APBFs are computed as follows:

$${AtatckParaValueOcc}_{i , j} [ n + 1 ] = {AtatckParaValueOcc}_{i , j} [ n ] \cdot ( 1 - α ) + {WinParaValueOcc}_{i , j} [ n + 1 ] \cdot α \qquad Equ . 4$$

where, AttackParaValueOcc_{i,j}[n] is the average occurrence for paraphrase value i, belongs to paraphrase j, for time window n, in APBFs. The WinParaValueOcc_{i,j}[n+1] is the total window occurrences for paraphrase value i, belongs to paraphrase j, as calculated in a time window n+1. The α is the alpha coefficient, which defines the Alpha filter “integration” period. In an example embodiment, the Alpha is selected as 0.75 to enable the fast integration time, e.g., a couple of seconds, required for the fast adaptation to the attacker requests' structure.

In another embodiment, building the APBFs includes computing distributions of attack paraphrase buffers. To this end, attack time paraphrase behavior with a short-time granularity, such as a one-second granularity, is computed. In an embodiment, the per-second paraphrase buffers are maintained for occurrences (or histograms) recording during a past time interval of, for example, 20 seconds. Then, a moving average is computed using an FIR filter over the maintained per-second paraphrase buffers.

Then, Attack Paraphrase Distributions are calculated for each “distribution window.” The duration of the distribution window may be, for example, 5 seconds or 10 seconds. This process is discussed in more detail below.

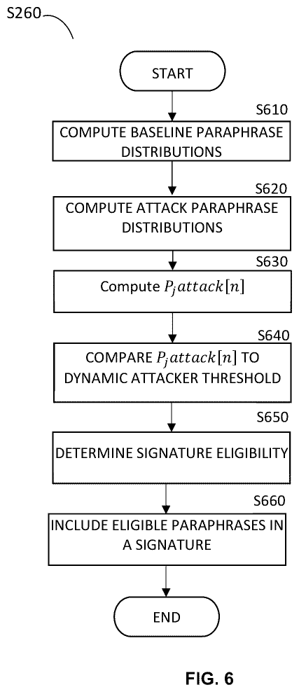

At S260, a signature of an attack tools (attacker) initiating the ongoing DDoS attack is generated based on the BPBFs and APBFs. The signature includes the optimal set of paraphrase values that can efficiently block the attacker-generated HTTP requests executing the application layer DDoS attack. S260 is discussed in greater detail in FIG. 6.

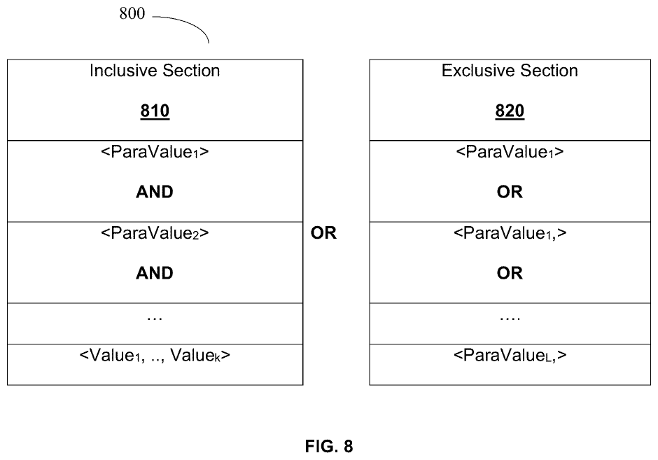

According to the disclosed embodiment, shown in FIG. 8. a signature 800 (or the signature) may include two sections: an inclusive section 810 and an exclusive section 820. The inclusive section 810 may include a list of paraphrase values of eligible paraphrases that meet the following conditions:
a. All of the attacker's transactions have paraphrase values of eligible paraphrases; and
b. Legitimate transactions may or may not include paraphrase values of eligible paraphrases.

As a result of applying the above conditions:
1. Incoming transactions are indicative of attacks only if all the paraphrase values in the inclusive section 810 are the same as its paraphrase vector corresponding paraphrase value; and
2. Incoming transactions are indicative of legitimate transactions and will be kept if at least one of the paraphrase values in the inclusive section 810 is different from its paraphrase vector corresponding paraphrase value.

The inclusive section 810 may also refer to a base signature. It should be noted that, in an embodiment, only when all paraphrase values in the base signature are matched to the incoming transaction will the transaction be blocked.

The exclusive section 820 includes a list of paraphrases that meet the following conditions:
a. Part of the attacker's transactions have these paraphrase values; and
b. Legitimate transactions cannot have the paraphrase's value.

An incoming transaction will be “blocked” only if at least one of the paraphrase values in the signature extension is the same as its paraphrase vector corresponding paraphrase value. Further, incoming (legitimate) transactions will be kept only if all the paraphrase values in the signature extension are different from its paraphrase vector corresponding paraphrase value. The exclusive section 820 may also refer to an extension signature. It should be noted that only one paraphrase value included in the exclusive section 820 has to be included in the transaction in order to block such a transaction.

The Boolean function between the inclusive section 810 and the exclusive section 820 is an “OR” function. The Boolean function among the paraphrase values in the inclusive section 810 is an “AND” function to block a transaction. The Boolean function among the paraphrase values in the exclusive section 820 is an “OR” function to block a transaction.

Paraphrase values in exclusive section 820 will be referred to hereinafter as exclusive paraphrase values. In an embodiment, an exclusive paraphrase value includes a value of a binary paraphrase (either static or dynamic). In another embodiment, the exclusive paraphrase value includes a single value from multiple value paraphrases.

An exclusive paraphrase value is selected such their peacetime probability is very low; that is, below a threshold that was set for exclusive paraphrase values and still was encountered during an attack. In an embodiment, the exclusive paraphrase values are selected to be a set of pre-defined numbers of paraphrase values with the highest attacker probability of appearance.

It should be noted that the type and number of paraphrase values may be different in each of the sections.

In an embodiment, both parts of the generated signature are provided to a mitigation resource to perform a mitigation action on attack traffic. To this end, the mitigation resource may be configured to compare each request to both parts of the generated signature and, if there is a match, apply a mitigation action on the request. It should be noted that S250 and S260, in FIG. 1, are performed as long as the attack is a DDoS attack. An indication of an end-of-attack may be received from the detector. Such an indication would halt the generation of new signatures and any mitigation actions. After the end of the attack, a detection action is indicated, and an attack mitigation grace period may be initiated. In an embodiment, the APBFs are not updated throughout the grace period time. The signature can be kept or removed during the grace period, predefined as part of the system configuration. The grace period is a preconfigured timeline.

A mitigation action may include blocking an attack tool at the source when the tool is being repetitively characterized as matched to the dynamic applicative signature. In the case where a client, identified by its IP address or X-Forwarded-For HTTP header, issues a large rate of HTTP requests that match with the dynamic applicative signature, this client can be treated as an attacker (or as an attack tool). After a client is identified as an attacker, all future HTTP requests received from the identified attacker are blocked without the need to perform any matching operation to the signature.

In some configurations, the matching of requests to signatures may include matching each relevant paraphrase of the request's paraphrase vector, to the signature. For the inclusive section 810 part of the signature, the match strictness can be configured to determine the sensitivity of the method.

The sensitivity may affect the false-positive ratio of legitimate requests detected as malicious. The range of a match can be determined as a percentage, where 100% would be when all the incoming paraphrase vector's values are the same as the corresponding signature. This strict match strategy can eliminate the false-positive ratio but may, in some cases, increase the false-negative ratio. To ease the matching requirements, the percentage of matching paraphrase vector's values would be, for example, between 80% and 90% (or match for all paraphrases besides 2 or 3 paraphrases). The matching percentage is a configurable parameter. The match strictness is defined in terms of the number of allowed unmatched paraphrases.

FIG. 4 is an example flowchart illustrating a process for generating a paraphrase vector according to an embodiment.

At S410, sampled HTTP requests are parsed. Specifically, the HTTP request's field headers, and other components, are parsed and processed. At S420, the information in the HTTP method's field is copied from the request into its corresponding “HTTP Method” paraphrase value cell in the vector. The value can be “GET,” “POST,” or “HEAD,” or any other HTTP method.

At S420, the number of path elements is counted from the URL path designated in the request. Every “\” is counted. For example, for the path “\pictures\images\2021\July\” the value is 4. For the root “\” its paraphrase is 0.

At S430, known HTTP headers are identified in the parsed request. This can be performed by first finding (e.g., using a regular expression) all strings designated as known headers. For example, the Accept* paraphrase is built by finding the existence of all HTTP headers starting with ‘Accept-*’ (e.g., Accept, Accept-Encoding, Accept-Language, and so on). If at least one Accept* header is found in a request, then the paraphrase value is EXIST. Otherwise, the paraphrase value will be NOT-EXIST. In an embodiment, the known headers include, yet are not limited to, the following headers: Referrer, User-Agent, Host, Authorization, Connection, Cache-Control, Date, Pragma, Expect, Forwarded, From, Max-Forwards, Origin, Prefer, Proxy-Authorization, Range, Transfer-Encoding, Upgrade, Via, Accept* (all HTTP headers that starts with Accept), Content* (all HTTP headers that start with Content), Sec—(all HTTP headers that start with Sec-), and If-* (all HTTP headers that start with If-), and similar HTTP headers, standard and not standard. In an embodiment, the known headers are defined using a static list of standard HTTP headers. In yet another embodiment, the known headers can be defined dynamically and learned upon their appearance in the incoming HTTP transactions.

At S440, all identified known headers are counted, and the respective value is set as a paraphrase value for the total number of “known HTTP headers.” Each appearance of a known header is counted as 1, and the total count of all headers “known HTTP headers” is set accordingly.

At S450, any header that is not identified (e.g., by the above-mentioned regular expression) is counted and added to the respective paraphrase, the total number of unknown headers. If no unknown headers are found, the respective paraphrase value is set to zero.

At S460, any cookie header in the received HTTP request is identified, and a number of key:value in the cookie, or simply the cookies, are counted and added to the respective paraphrase, the total number of key:value in cookie. If no cookie header is found, the respective paraphrase value is set to zero.

At S470, any query arguments in the URL of the received HTTP request are identified and parsed, and the total number of query arguments URL are counted and set at the respective paraphrase, the number of query arguments in the request URL. If no query argument is found, the respective paraphrase value is set to zero.

At S480, the User Agent and the total length of the received HTTP request are identified and parsed. Further, the length of User-Agent header is counted and set to the respective paraphrase, the length of User-Agent header. If no User-Agent HTTP header is found, the respective paraphrase value is set to zero. The same applies to the User-Agent actual value. Furthermore, the total length in bytes of the received HTTP request is counted and set to the respective paraphrase, the total length of HTTP requests. In an embodiment, the total length of the HTTP request is defined by ranges, e.g., 0-99, 100-199, until 390-3999 bytes. In yet another embodiment, the count of origin of the source IP generated by the request (GEO IP) is identified and set, and the source IP can be defined by the Layer 3 IP headers or by the X-Forwarded FOR HTTP header.

The processes described herein are performed for sampled HTTP requests sent by both client device 120 and/or the attack tool 125 toward the victim server 130 (as in FIG. 1). The requests can be converted into one or more paraphrases, each of which with a respective paraphrase vector.

Further embodiments include identifying and setting the client's geo IP address, as well as identifying and setting the client's geo IP address and the HTTP version. Additionally, identifying and setting dynamic phrases such as HTTP header keys, cookies in cookie keys, and query argument keys.

FIG. 6 shows an example flowchart S260 illustrating the process of generating the signature of an attack tool (attacker) during an active attack and according to an embodiment. This process is realized at the end of each time window during an active attack. The time window can be of 5 seconds, 10 seconds, and the like.

At S610, baseline paraphrase distributions are computed using the BPBFs. This may include transforming the baseline paraphrase histogram (represented by the BPBFs) to a probability distribution function. In an embodiment, the baseline paraphrase distributions are computed as follows:

$${BaselineParaValueProb}_{i , j} [ n ] = \frac{{ParaValueOccMean}_{i , j} [ n ]}{{\sum }_{k} {ParaValueOccMean}_{k , j} [ n ]} \qquad Equ . 5$$

where, the BaselineParaValueProb_{i,j}[n] is the probability of the appearance of Paraphrase Value i, belonging to Paraphrase j, for time window n. The ParaValueOccMean_{i,j}[n] is the average (baseline) occurrences for Paraphrase Value i, belongs to Paraphrase j, for time window n, as recorded in the baseline paraphrase buffers.

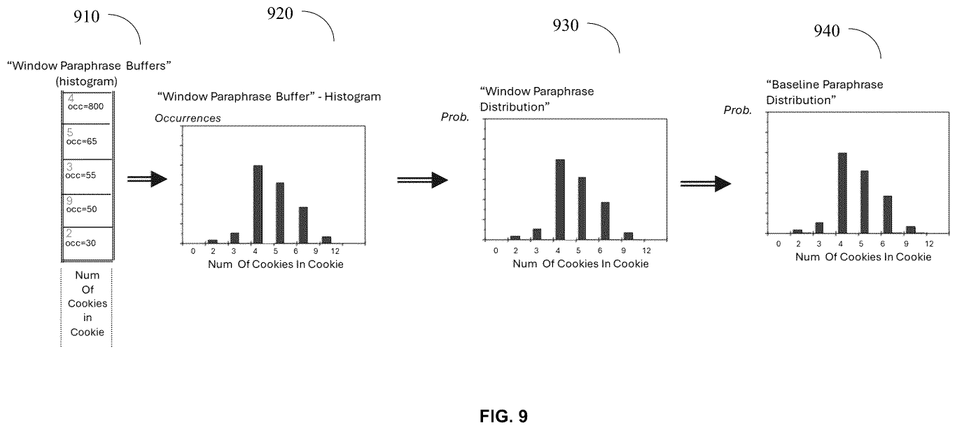

In yet another embodiment, the baseline paraphrase distributions are computed based on Window Paraphrase Distributions continuously during peacetime (i.e. not just upon attack). This process is described with reference to FIG. 9.

Referring now to FIG. 9, the Paraphrase Buffers 910 maintains occurrences for paraphrase values. In the example shown in FIG. 9, the paraphrase value is “Num Of Cookies in Cookie”. The representation of the Paraphrase Buffers for a paraphrase value is a histogram, as shown in Graph 920. Then, using the histogram (accumulated during a time window defined for peacetime), the Window Paraphrase Distributions are computed. The computation may be performed using the following equation:

$${WinParaValueProb}_{i , j} [ n ] = \frac{{ParaValueWinOcc}_{i , j} [ n ]}{{\sum }_{k} {ParaValueWinOcc}_{k , j} [ n ]} \qquad Equ . 6$$

Where, WinParaValueProb_{i,j}[n] is the probability of the appearance of a paraphrase value i, belonging to a paraphrase j, for a time window n; and ParaValueWinOcc_{i,j}[n] is the last time window occurrences for a paraphrase value i, belonging to a paraphrase j, for a time window n, taken from a Window Paraphrase Buffer. The time window configurable parameter, e.g., 5 minutes, can be a dedicated time window period for peacetime. In yet another embodiment, the time window size is defined dynamically. The computed Window Paraphrase Distributions is labeled as 930 in FIG. 9.

Then, using the computed Window Paraphrase Distributions, the Baseline Paraphrase Distributions are computed using the following equation:

$${BaselineParaValueProb}_{i , j} [ n + 1 ] = {BaselineParaValueProb}_{i , j} [ n ] \cdot ( 1 - α ) + {WinParaValueProb}_{i , j} [ n + 1 ] \cdot α$$

where, ParaValueProbBaseline_{i,j}[n] is the average baseline probability for Paraphrase Value i, belonging to Paraphrase j, for a time window n; WinParaValueProb_{i,j}[n] is the window probability for Paraphrase Value i, belonging to Paraphrase j, as calculated in the time window; and a is a coefficient defining an IIR filter “integration” period. A graph showing a calculated Baseline Paraphrase Distribution is labeled as 940 in FIG. 9.

Referring now back to FIG. 6, at S620, and during an active attack, attack paraphrase distributions are computed using the APBFs. This may include a transformation attack paraphrase histogram (represented by the APBFs) to a probability distribution function. In an embodiment, the attack paraphrase distributions are computed as follows:

$${AttackParaValueProb}_{l , j} [ n ] = \frac{P a r a {ValueOccMean}_{i , j} [ n ]}{{\sum }_{k} P a r a {ValueOccMean}_{k , j} [ n ]} \qquad Equ . 7$$

where, AttackParaValueProb_{i,j}[n] is the probability of appearance of Paraphrase Value i, belongs to Paraphrase j, for time window n of an active attack. The ParaValueOccMean_{i,j}[n] is the aggregated occurrences for Paraphrase Value i, belongs to Paraphrase j, for time window n, as recorded in the attack paraphrase buffers.

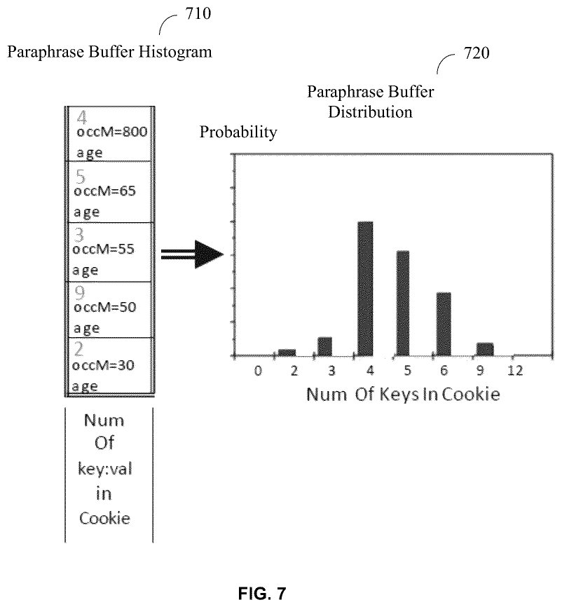

An example demonstrating the transformation from a histogram to paraphrase distributions (either for attack or baseline) is shown in FIG. 7. In this example, the paraphrase is the “Num of key:val in Cookie”. The respective paraphrase is labeled 710 and the distribution graph is labeled 720.

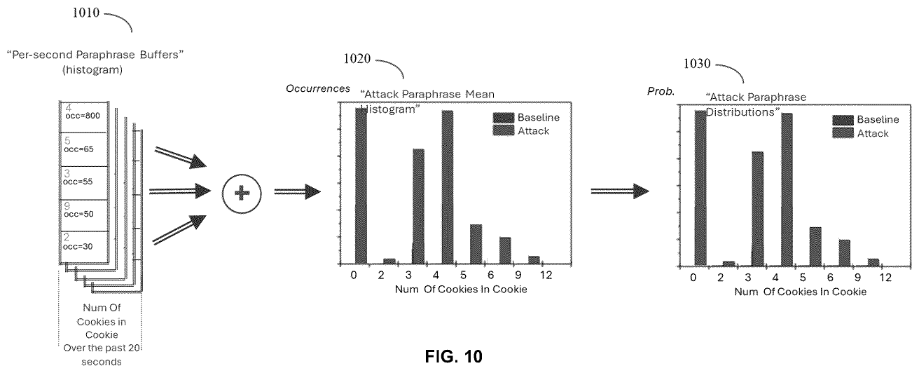

In another embodiment, the process for computing the Attack Paraphrase Distributions is based on per-second paraphrase buffers. This process is further demonstrated in FIG. 10. The paraphrase value of “Num of cookies” is illustrated in FIG. 10. It should be noted that “Num of key: value in Cookie” and “Num of cookies” and “Num Of Cookies in Cookie” refer to the same paraphrase value.

The per-second paraphrase buffers 1010 maintains occurrences for paraphrase values in transactions received during time intervals of 1 second. In the example shown in FIG. 10, the paraphrase value is “Num Of Cookies in Cookie”. The representation of the Paraphrase Buffers 1010 is a histogram, which is transformed into the “Attack Paraphrase Mean Histogram”, shown in graph 1020. The “Attack Paraphrase Mean Histogram” is computed as a moving average, for example, over 20 seconds. In an embodiment, the computation may be performed using the following equation:

$$A t t a c k P a r a V a l u {eMeanOcc}_{i , j} [ t ] = {\sum }_{i = 0}^{T m v - 1} A t t a c k P a r a {ValueOcc}_{i , j} [ t - i ] \qquad Equ . 8$$

Where, AtatckParaValueMeanOcc_{i,j}[t] is the mean attack time occurrences appearance of Paraphrase Value i, belongs to Paraphrase j, for time t in seconds, and AtatckParaValueOcc_{i,j}[t] is the per-second attack time occurrences for Paraphrase Value i, belonging to a paraphrase j, for a time ‘t’, taken from per-second paraphrase buffers. It should be noted that the Tmv or the size of the moving average buffer, or the FIR filter size, is a configurable parameter and can be set, for example, to 20 seconds. In another embodiment, the FIR filter can be built using a different coefficient to each of its taps (or one-second paraphrase buffer), allowing providing different weights to each of the past seconds, e.g., later seconds have more influence than the former.

Then, using the computed Histogram 1020, the Attack Paraphrase Distributions 1030 are calculated using the following equation:

$${AttackParaValueProb}_{i , j} [ n ] = \frac{{AttackParaValueOccMean}_{i , j} [ n ]}{{\sum }_{k} {AttackParaValueOccMean}_{k , j} [ n ]}$$

where, the AttackParaValueProb_{i,j}[n] is the probability of appearance of Paraphrase Value i, belonging to Paraphrase j, for a time window n; AttackParaValueOccMean_{i,j}[n] is a window probability for Paraphrase Value i, belonging to Paraphrase j, as calculated in time t=n and each ‘x’ seconds windows. In an embodiment, ‘x’ is a configurable parameter, and can be set as, for example, 5 seconds, 10 seconds, or similar. Graph 930 shows a calculated as an Attack Paraphrase Distributions. It should be noted that S610 and S620 may be performed at different times or in parallel.

At S630, a probability Pⱼattack[n] of an attacker to generate an attack using a specific paraphrase (j), for each specific paraphrase value is computed. In an embodiment, the Pⱼattack[n] is computed as follows:

$${P}_{j} attacker [ n ] = {P}_{j} attack [ n ] \cdot \frac{1 + A F [ n ]}{A F [ n ]} - {P}_{j} baseline \cdot \frac{1}{A F [ n ]} \qquad Equ . 9$$

where, Pⱼattack[n] and Pⱼbaseline are derived from the computed attack paraphrase distributions and baseline paraphrase distributions, respectively calculated according to the various embodiments described hereinafter. The function AF[n] is the attack factor, i.e. the RPS generated by the attacker divided by the RPS generated by the legitimate clients:

$$A F [ n ] = \frac{AttackerRPS [ n ]}{LegitRPS [ n ]} \qquad Equ . 10$$

and may be completed as follows:

$$A F [ n ] = {\sum }_{l = 1}^{n - a . d . t} \frac{( A t t a c k R S P [ l ] - B a s e l i n e R P S )}{B a s e l i n e R P S} \qquad Equ . 11$$

where, ‘a.d.t.’ is the actual attack detection time, and ‘n’ is the current time window. AttackRPS[n] is the true average RPS as measured during the time window ‘n’ when the attack is active. The BaselineRSP represents the average legitimate RPS as a measure before the attack has started. In an embodiment, the BaselineRSP is computed as an average over one one-hour period before the attack has started. In yet another embodiment, the BaselineRSP is computed as the summation of an average over one one-hour period before the attack has started and a predefined number of corresponding standard deviations.

In cases, the APBFs average paraphrase values are computed using Equ. 4, the AF[n] is calculated as an average using an Alpha filter over AF[n] values using:

$$A F [ n + 1 ] = A F [ n ] \cdot ( 1 - α ) + \frac{AttackRPS [ n + 1 ] - B a s e l i n e R P S}{B a s e l i n e R P S} α \qquad Equ . 12$$

In an example embodiment, with correspondence to Equ.4, the Alpha is selected as 0.75 to enable the fast integration time, e.g., a couple of seconds, required for the fast adaptation to the attacker requests' structure. It should be noted that the S630 is performed for each paraphrase.

In yet another embodiment, when the embodiment to calculate attack paraphrase probability is defined in FIG. 10 using moving average, the AttackFactor can be changed per second and defined using the following equation:

$$S e c A F [ t ] = \frac{( IngressRSP [ t ] - B a s e l i n e R P S )}{B a s e l i n e R P S} \qquad Equ . 13$$

and the AttackFactor can be computed as a moving average using the following equation:

$$A F [ n ] = \frac{1}{T m v} {\sum }_{i = 0}^{T m v - 1} \frac{( l n g r e s s R S P [ n - i ] - B a s e l i n e R P S )}{B a s e l i n e R P S} \qquad Equ . 14$$

where, Tmv is a configurable parameter, e.g., 20 seconds.

At S640, the attacker probabilities Pⱼattacker[n], for each paraphrase j and each of its values are compared to a predefined dynamic attacker threshold. All the respective paraphrase values of attacker probabilities Pⱼattacker[n] exceeding the threshold are added to an attacker buffer, and the rest paraphrase values are added to a legitimate buffer. The paraphrase values in the attack buffer are candidates to be included in the adaptive signature. That is, such paraphrase values are likely to be executed by an attacker and generated on an ongoing basis by the attack tools the attacker is using. In an embodiment, the attacker threshold is preconfigured and defined by the mitigation sensitivity attribute.

In another embodiment, S640 includes comparing attacker probabilities Pⱼattacker[n], for each paraphrase ‘j’ and each of its values is compared to a dynamic attacker threshold. All the respective paraphrase values of attacker probabilities Pⱼattacker[n] exceeding the dynamic attacker probability threshold are added to an attacker buffer, and the rest of the paraphrase values are added to a legitimate buffer. In an embodiment, the dynamic attacker probability threshold can be defined using a number of attributes:
Dynamic_Attack_Factor is the value of AF[n] the algorithm can start decreasing the Attacker_probability_TH
Static_Attacker_probability_TH is the attacker probability start value, which can be defined by the mitigation sensitivity configuration (e.g. for medium sensitivity=5%, high (aggressive) sensitivity=3%, low sensitivity=8%)
Attacker_probability_LOW_TH is the attacker probability minimum value.

In an embodiment, the dynamic attacker probability threshold (TH) is defined as follows:

```
  If AF[n] < Dynamic_Attack_Factor
    Attacker_probability_TH = Static_Atatcker_probability_TH
  else:
    Attacker_probability_TH = Dynamic_Atatck_Factor *
Static_Attacker_probability_TH / AF[n]
  Attacker_probability_TH = max{Attacker_probability_TH ,
Attacker_probability_LOW_TH }
```

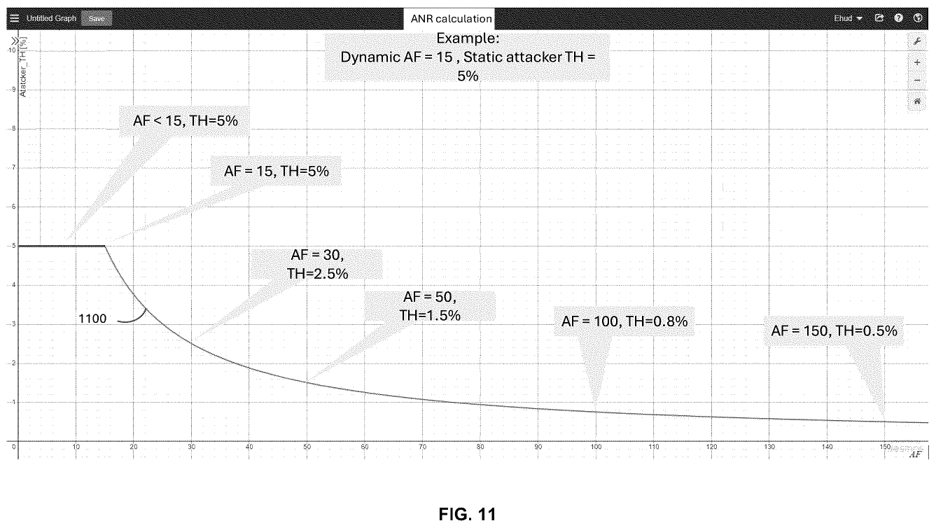

A graph showing the Attacker_proabilitity_TH as a function AF[n] and the static threshold is shown in FIG. 11. As can be noticed in FIG. 11, as the AF[n] increases the Attacker_probability_TH decreases, or that the Attacker_proabilitity_TH is in a reverse proportion to the AF[n]. In another embodiment, the Attacker_proabilitity_TH can be decayed by the AF[n] depending on the size of the AF, such that for a higher AF[n] value, the Attacker_proabilitity_TH decreases lower slowly.

At S650, the signature eligibility of each paraphrase is determined. That is, the signature eligibility determines if the respective paraphrase values of each paraphrase in the attacker buffer should be included, or not included in the signature. The eligibility is determined by summing the baseline (peacetime) distributions of all paraphrase values in the legitimate buffer and comparing the summation to a predefined legitimate threshold. If the distribution sum exceeds the legitimate threshold, the paraphrase values in the attacker buffer are considered signature-eligible, resulting in the paraphrase being eligible to be included in the signature. If the distribution sum does not exceed the legitimate threshold, the paraphrase is not eligible and is eliminated from the signature, or the paraphrase is not part of the signature. This activity ensures the efficiency of the generated signature. In an embodiment, the legitimate threshold is preconfigured and defines the mitigation or sensitivity.

At S660, all paraphrase values that are signature-eligible are added to a data structure representing the inclusive part of signature, characterizing the attacker executing the ongoing attack. In an embodiment, the signature characterizes the attacker and is further used in the next time window for the actual attack mitigation.

Following are two examples, showing eligible and non-eligible paraphrases for the inclusive part of signature. In the first example, the paraphrase is Num of Keys in Cookie. The paraphrase values are ‘0’, ‘1’, ‘2’, ‘3’, ‘4’, ‘5’, and ‘6’. The computed Pⱼattacker is as follows: Pⱼattacker(paraValue=0)=0.495; Pⱼattacker(paraValue=1)=0.098; Pⱼattacker(paraValue=2)=0.098; Pⱼattacker(paraValue=3)=0.101; Pⱼattacker(paraValue=4)=0.104; Pⱼattacker(paraValue=5)=0.102; and Pⱼattacker(paraValue=6)=0

The attacker threshold is dynamically set at 0.1, thus, all values but “paraValue=6” will be included in the attacker buffer. The legitimate threshold is 0.01, The total legitimate probability is 23%, and thus the paraphrase (Num of Keys in Cookie) is eligible and will be included in the attacker's signature. This enables signature accuracy and efficacy.

In the second example, the paraphrase is a HTTP method. The paraphrase values are ‘GET’, ‘POST’, ‘DELETE’, ‘HEAD’, and ‘PUT’. The computed Pⱼattacker values are: Pⱼattacker(paraValue=GET)=0.498; Pⱼattacker(paraValue=POST)=0.501; Pⱼattacker(paraValue=DELETE)=0; Pⱼattacker(paraValue=HEAD)=0; and Pⱼattacker(paraValue=PUT)=0.

The attacker threshold is dynamically set to 0.2. Thus, all 2 values, ‘GET’ and ‘POST’, will be included in the attacker buffer. The total legitimate probability is about 0%, and thus, the paraphrase (HTTP method) is ineligible and will not be included in the attacker's signature.

In an embodiment, “exclusive” paraphrase values to be included in the exclusive section of the signature are values of static and dynamic binary paraphrases and a single value from multiple value paraphrases selected based on the computed Pⱼattacker and their peacetime probability of appearances Pⱼbaseline. A paraphrase is eligible to be an exclusive paraphrase when the following conditions are met:
1. An exclusive paraphrase's peacetime probability is very low: P_{baseline}<exclusive paraphrase peacetime threshold, can be any preconfigured low value.
2. An exclusive paraphrase was hit by the attacker: P_{attacker}>Attacker Probability Exclusive TH

Specifically, eligible exclusive paraphrase values include a set of a pre-defined number (e.g., 10) of paraphrase values with the highest attacker probability Pⱼattacker.

The described methods allow for the creation of application-layer signatures to help in mitigation of HTTP Floods DDoS attacks. Even though the process takes into account many paraphrases and their peacetime and attack time values, it is possible for a created signature to potentially result in either a false positive or a false negative mitigation, leading to inferior mitigation performance. This means that legitimate transactions could be incorrectly blocked and malicious traffic could be mistakenly identified as legitimate transactions and passed toward the protected server. A large number of dynamic paraphrases can impose a long signature that requires an unnecessarily large volume of mitigation resources; the finetuned signature is optimal for mitigation with a lower consumption of mitigation resources. Therefore, the disclosed methods include a fine-tuning process aimed at reducing the occurrence of false positives and false negatives with an optimal set of dynamic paraphrases included in the signature.

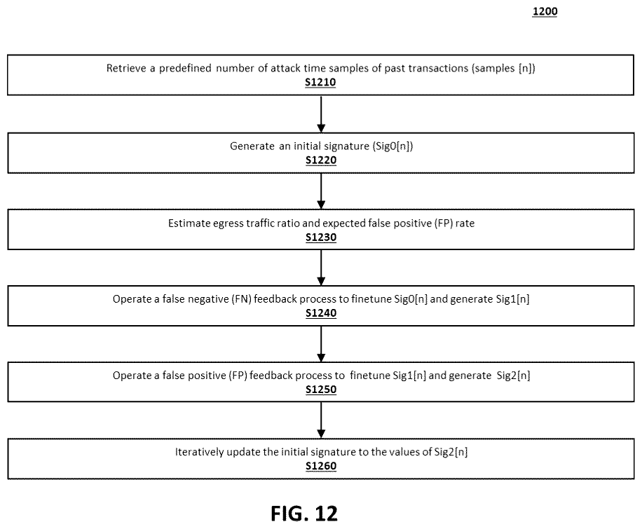

FIG. 12 is an example flowchart 1200 for finetuning application-layer signatures according to an embodiment. In some implementations, the method of FIG. 12 may be performed by the device 170.

At S1210, a predefined number of samples of past incoming transactions are retrieved. In an embodiment, S1210 includes retrieving predefined samples from transactions received and processed during a previous time, or past, time window ‘n’. In another embodiment, the time window can be 5 seconds, 10 seconds, 20 seconds, and so on. Such samples may be denoted in an embodiment as “samples[n]”.

At S1220, an initial application-layer signature (Sig0[n]) is generated from the past samples, samples[n]. The process for generating the initial application-layer signature is the same as the process for generating application-layer signatures discussed in detail above. At S1230, the generated initial application-layer signature Sig0[n] is applied to samples[n] to estimate the initial expected egress traffic rate, in RPS, and the expected false positive rate. In an embodiment, the estimated egress traffic rate is computed as a ratio between the number of samples not blocked by the signature Sig0[n], when applied on past samples[n], and the total number of past samples in samples[n], multiplied by the actual real RPS measured over the past time windows. In an embodiment, the estimated egress traffic may be computed as follows:

$$EstimatedEgress 0 [ n ] = \frac{number of samples not blocked by Sig 0 [ n ]}{Total number of samples in sample [ n ]} \times TrueIngressRPS \qquad Equ . 15$$

In another embodiment, the estimated FP rate is computed as a ratio between the number of legitimate transactions blocked by the initial signature Sig0[n] and a number representing a total number of legitimate transactions. In an embodiment, the estimated FP rate may be computed as follows:

$$EstimatedFP 0 [ n ] = \frac{n umber of legit transaction blocked by Sig 0 [ n ]}{Total number of legit transactions} \qquad Equ . 16$$

In an embodiment, legitimate transactions are a predefined number of legitimate transactions samples collected from samples transactions received and processed during peacetime, all with the objective of representing the legitimate traffic structure and behavior. In another embodiment, legitimate transactions are collected each time period (e.g., 1 hour, 24 hours, etc.). The number of total legitimate transactions is configurable; for example, in an embodiment, it can be a few, thousands. The number may be represented by a value of ‘5000’.

At S1240, a false negative (FN) feedback process is applied to Sig0[n] to generate a first finetuned signature Sig1 [n], with the objective of ensuring a satisfactory level of FN and FP. In an embodiment, Sig1 [n] includes the initial signature and added paraphrase values. The FN feedback process includes iterations for augmenting the initial signature Sig0[n] with paraphrase values to generate the Sig1 [n] until a termination condition is met. The termination condition may include estimated egress traffic being reduced below a pre-defined RPS attack threshold while the estimated FP rate is kept below a pre-defined FP rate threshold. It should be noted that when the FP rate imposed by Sig0[n] is below the RPS attack threshold, no augmentation is added to Sig0[n] and it is simply set as the required Sig0[n].

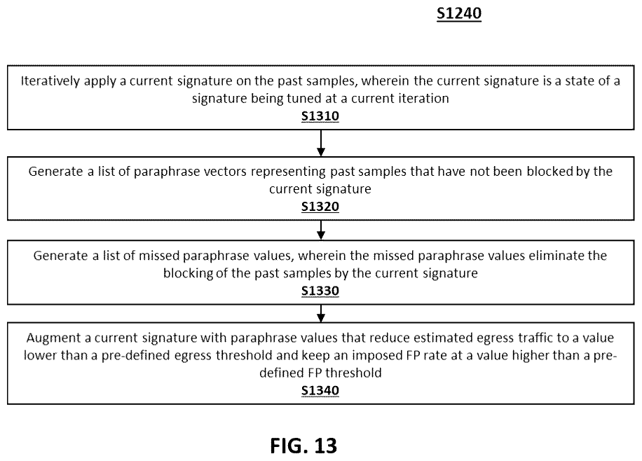

FIG. 13 shows a flowchart S1240 describing the false negative feedback process according to an embodiment.

A current signature is first applied to the past samples (S1310). In an embodiment, the past samples are applied to samples[n]. The current signature is a state of a signature being tuned at a current iteration. Then, at S1320, a list of paraphrase vectors representing past samples that have not been blocked by the current signature is generated. Paraphrase vectors are discussed in detail above. At S1330, a list of missed paraphrase values is generated. In an embodiment, missed paraphrase values are such values that eliminate the blocking of the past samples by the current signature.

The process further includes, at S1340, from the missed list of paraphrase values, augmenting a current signature with paraphrase values that reduce estimated egress traffic to a value lower than a pre-defined egress threshold and keeping an estimated FP rate at a value lower than a pre-defined FP threshold. The actual calculation of the estimated egress traffic and estimated FP are the same as detailed above. In an embodiment, the pre-defined egress threshold is defined according to the RPS rate used as the HTTP Floods attack threshold, dynamically calculated by a detection system. The techniques for computing the attack RPS threshold are outside of the scope of the disclosed embodiments.

In an embodiment, the iterative process includes a selection of a number of (e.g., 5) top missed paraphrase values, or missed paraphrase values with the maximum number of samples that were not blocked by the current signature. Then, for each of the missed paraphrases, starting with the one with the maximum samples transactions not blocked, the process tries augmenting the current signature by calculating the estimated egress RPS and FP imposed by the augmented signature. If the estimated FP is above the pre-defined threshold, the process continues checking the next missed paraphrase value. If the estimated FP is below the pre-defined threshold, then the augmentation of the signature is accepted, and the next iteration is executed. In an embodiment, the false negative feedback process stops when the augmented signature imposes an estimated egress traffic that is lower than the pre-defined egress threshold, or until a pre-defined number of iterations are concluded.

The false negative feedback process is performed iteratively until a termination condition is met. As noted above, the termination condition may be met when the estimated egress traffic decreases below an RPS attack threshold and an imposed FP rate is below a pre-defined FP rate threshold. In an embodiment, the Sig1[n] is set to the current signature when the false negative feedback process S1240 is terminated.

Returning to FIG. 12, at S1250, a false positive (FP) feedback process is applied to Sig1 [n] to generate a second fine-tuned signature, Sig2[n]. In an embodiment, the FP feedback process is iteratively performed to generate an optimal set of paraphrase values that can be added to Sig2[n]. In an embodiment, such a set of paraphrase values may include binary and non-binary paraphrases, and static or dynamic paraphrases.

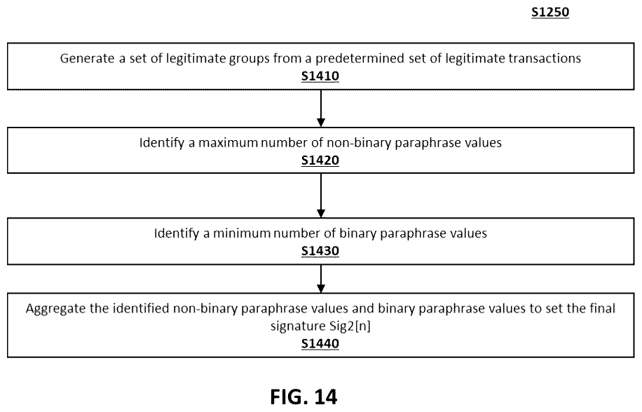

FIG. 14 shows an example flowchart S1250 of the false positive feedback process according to an embodiment. At S1410, a set of legitimate groups from a predetermined set of legitimate transactions is generated. The legitimate transactions are saved during peacetime (i.e., when no attack is detected). In an example embodiment, the set of legitimate transactions includes 5,000 transactions collected from the received samples each pre-defined period of time. The set of legitimate groups include their corresponding set of paraphrase vectors generated from the list of legitimate transactions.

At S1420, a maximum number of non-binary paraphrase values that causes minimal blocking of legitimate transactions from the predetermined set of legitimate transactions is identified. In an embodiment, S1420 includes adding all multiple value paraphrases in Sig1 [n] to Sig2[n]. That is, all legitimate transactions that are “saved”, or not blocked, are removed, relying on the multiple values paraphrase from Sig1 [n]. In an embodiment, all the legitimate transactions whose corresponding paraphrase vectors hold paraphrase values different than those that appeared in the multiple values paraphrase in Sig1 [n] are removed from the legitimate transactions list.

Further, S1430 includes identifying a minimum number of binary paraphrase values that causes minimal blocking of legitimate transactions, which remain after the removal of transactions described above.

At S1440, the identified non-binary paraphrase values and binary paraphrase values are aggregated to set the final signature Sig2[n].

In an embodiment, the false positive feedback process is performed until termination conditions are met. The termination conditions are met when a predefined range of numbers of added binary paraphrase values, and the size of the current legitimate groups decreases below a predefined allowed FP threshold (e.g., 10%).

Returning to FIG. 12, at S1260, the initial signature is updated to the values of the Sig2[n] to generate a fine-tuned application-layer signature used for attack mitigation. As the process discussed with reference to FIG. 12 is iterative, the update of the initial signature is also performed iteratively.

Although FIG. 12 shows example blocks of process 1200, in some implementations, process 1200 may include additional blocks, fewer blocks, different blocks, or differently arranged blocks than those depicted in FIG. 12. Additionally, or alternatively, two or more of the blocks of process 1200 may be performed in parallel.

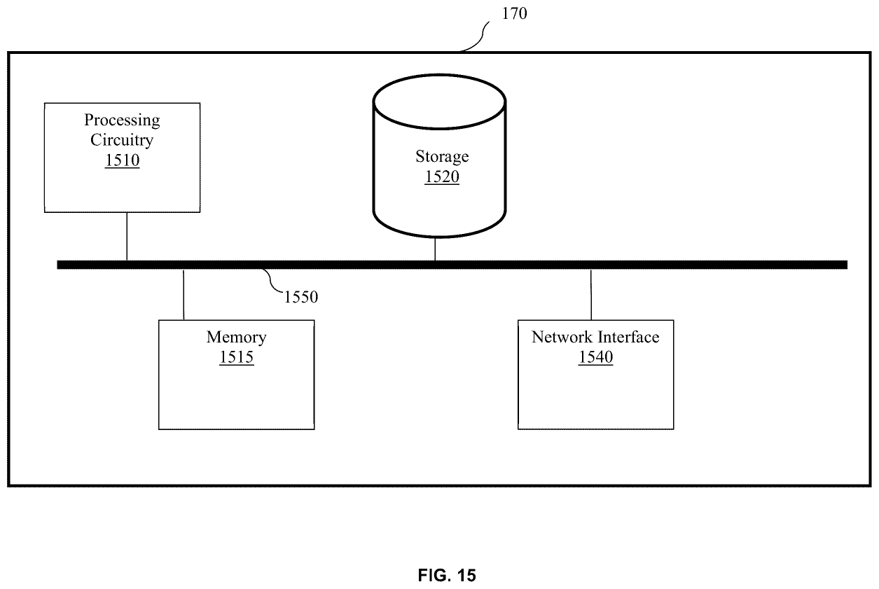

FIG. 15 is an example block diagram of the device 170 implemented according to an embodiment. The device 170 includes a processing circuitry 1510 coupled to a memory 1515, a storage 1520, and a network interface 1540. In another embodiment, the components of the device 170 may be communicatively connected via a bus 1550.

The processing circuitry 1510 may be realized as one or more hardware logic components and circuits. For example, and without limitation, illustrative types of hardware logic components that can be used include field-programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 1515 may be volatile (e.g., RAM, etc.), non-volatile (e.g., ROM, flash memory, etc.), or a combination thereof. In one configuration, computer-readable instructions to implement one or more embodiments disclosed herein may be stored in storage 1520.

In another embodiment, the memory 1515 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by one or more processors, cause the processing circuitry 1510 to perform the various processes described herein. Specifically, the instructions, when executed, cause the processing circuitry 1510 to perform the embodiments described herein.

The storage 1520 may be magnetic storage, optical storage, and the like, and may be realized, for example, as flash memory or other memory technology, CD-ROM, Digital Versatile Disks (DVDs), or any other medium that can be used to store the desired information.

The network interface 1540 allows the device to communicate at least with the servers and clients. It should be understood that the embodiments described herein are not limited to the specific architecture illustrated in FIG. 15, and other architectures may be equally used without departing from the scope of the disclosed embodiments. Further, system 170 can be structured using the arrangement shown in FIG. 15.

The various embodiments disclosed herein can be implemented as hardware, firmware, software, or any combination thereof. Moreover, the software is preferably implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to promoting the art and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

1. A method for generating application-layer signatures characterizing advanced application-layer attacks, comprising:
computing, based on applicative peacetime baseline distributions and attack distributions of applicative attributes included in application-layer transactions directed to a protected entity, an attacker probability of an attacker executing an ongoing application-layer attack;
comparing the attacker probability computed for each of the applicative attributes to a dynamic attacker probability threshold; and
including in an application-layer signature eligible applicative attributes having an attacker probability higher than the dynamic attacker threshold, wherein the application-layer signature includes an inclusive section and an exclusive section, and wherein the application-layer signature is indicative of an ongoing attack based on one of the exclusive section and the inclusive section.

2. The method of claim 1, wherein the dynamic attacker probability threshold is dynamically calculated with a reverse ratio to a current attack factor (AF).

3. The method of claim 1, further comprising:
determining, based on attacker probabilities, an eligibility threshold of applicative attributes to be included in the generated application-layer signature.

4. The method of claim 1, wherein attacker probabilities (Pj attacker[n]) are computed as follows:
$${P}_{j} attacker [ n ] = {P}_{j} attack [ n ] \cdot \frac{1 + A F [ n ]}{A F [ n ]} - {P}_{j} baseline \cdot \frac{1}{A F [ n ]}$$
wherein, Pⱼattack[n] are derived from computed attack paraphrase distributions, Pⱼbaseline are derived from baseline paraphrase distributions, and AF is an attack factor.

5. The method of claim 4, further comprising:
sampling transactions received during a time window;
for each time window,
building a set of window paraphrase buffers (WPBFs); and
building a set of baseline paraphrase buffers (BPBFs) from transactions directed to the protected entity during peacetime, wherein the BPBFs represent a paraphrase distribution of normal behavior.

6. The method of claim 5, further comprising:
sampling transactions received during a time window;
for each time window,
building a set of per-second paraphrase buffers; and
building, from each per-second paraphrase buffers, attack paraphrase distributions from transactions received during an on-going application-layer attack, wherein the attack paraphrase distributions represent paraphrases distributions for a duration of the on-going application-layer attack.

7. The method of claim 6, wherein building the set of WPBFs and per-second paraphrase buffers further comprises:
vectoring a set of paraphrases derived from the received transactions during a time window; and
buffering the paraphrase vectors to provide the WPBFs and per-second paraphrase buffers.

8. The method of claim 7, wherein building the set of BPBFs further comprises:
updating values from the WPBFs into the BPBFs.

9. The method of claim 8, further comprising:
computing paraphrase values mean occurrences for the BPBFs for a current time window based on an average of distributions for paraphrase values in the BPBFs computed for a previous time window, a total of distributions for paraphrase values in the WPBFs for a current time window, and an IIR filter.

10. The method of claim 9, wherein building the attack paraphrase distributions further comprises:
updating the distributions from the per-second paraphrase buffer into the attack paraphrase mean histogram; and
updating paraphrase value distributions based on transactions directed to the protected entity during an ongoing application-layer attack.

11. The method of claim 10, wherein updating the attack paraphrase distributions further comprises:
computing paraphrase values mean distributions for a current time window, over a pre-defined set of per-second distributions for paraphrase values computed for a previous second, a total occurrences for paraphrase values in the pre-defined set of per-second distributions, and an FIR filter, wherein the FIR filter is configured with various weights over the past seconds.

12. The method of claim 3, further comprising:
maintaining applicative attributes of transactions, directed to the protected entity, in a paraphrase, wherein each paraphrase includes at least one paraphrase value, wherein a paraphrase value represents an applicative attribute in a transaction.

13. The method of claim 12, further comprising:
setting at least one dynamic paraphrase, wherein the dynamic paraphrase includes any one of: an HTTP header key, a cookie key in cookie header, and a query argument key.

14. The method of claim 1, wherein the exclusive section includes a plurality of paraphrase values, wherein the application-layer signature is indicative of an ongoing attack based on all of the plurality of paraphrase values.

15. The method of claim 14, wherein the inclusive section includes a plurality of paraphrase values, wherein the application-layer signature is indicative of an ongoing attack based on at least one of the plurality of paraphrase values.

16. The method of claim 1, further comprising:
determining based, in part, on an attacker probability a set of paraphrase values to be included in the inclusive section.

17. The method of claim 16, further comprising:
selecting a set of a pre-defined number of paraphrase values with a highest attacker probability and lower than a pre-defined threshold baseline probability to be included in the exclusive section.

18. The method of claim 1, wherein the attacker can be blocked based on at least one applicative attribute included in the exclusive section.

19. The method of claim 1, wherein the ongoing application-layer attack is a DDoS attack realized as an HTTP flood application-layer attack.

20. The method of claim 1, further comprising:
finetuning application-layer signatures to reduce a false negative rate, while reducing an estimated egress traffic below a RPS attack threshold and an imposed FP rate below a pre-defined FP rate threshold.

21. The method of claim 20, wherein finetuning the application-layer signatures further comprises:
retrieving a predefined number of attack time samples of past transactions (samples[n]);
generating an initial signature (Sig0[n]) from the past samples;
operating a false negative (FN) feedback process to finetune the Sig0[n] to generate a first finetuned signature Sig1 [n];
operating a false positive (FP) feedback process to finetune the Sig1 [n] to generate a second finetuned signature Sig2[n]; and
iteratively updating the initial signature to values of the Sig2[n] to generate a finetuned application-layer signature used for attack mitigation.

22. A non-transitory computer-readable medium storing a set of instructions for generating application-layer signatures characterizing advanced application-layer attacks, the set of instructions comprising:
one or more instructions that, when executed by one or more processors of a device, cause the device to:
compute, based on applicative peacetime baseline distributions and attack distributions of applicative attributes included in application-layer transactions directed to a protected entity, an attacker probability of an attacker executing an ongoing application-layer attack;
compare the attacker probability computed for each of the applicative attributes to a dynamic attacker probability threshold; and
include in an application-layer signature eligible applicative attributes having an attacker probability higher than the dynamic attacker threshold, wherein the application-layer signature includes an inclusive section and an exclusive section, and wherein the application-layer signature is indicative of an ongoing attack based on one of the exclusive section and the inclusive section.

23. A device for generating application-layer signatures characterizing advanced application-layer attacks comprising:
one or more processors configured to:
compute, based on applicative peacetime baseline distributions and attack distributions of applicative attributes included in application-layer transactions directed to a protected entity, an attacker probability of an attacker executing an ongoing application-layer attack;
compare the attacker probability computed for each of the applicative attributes to a dynamic attacker probability threshold; and
include in an application-layer signature eligible applicative attributes having an attacker probability higher than the dynamic attacker threshold, wherein the application-layer signature includes an inclusive section and an exclusive section, and wherein the application-layer signature is indicative of an ongoing attack based on one of the exclusive section and the inclusive section.

24. The device of claim 23, wherein the dynamic attacker probability threshold is dynamically calculated with a reverse ratio to a current attack factor (AF).

25. The device of claim 23, wherein the device is further configured to:
determine, based on attacker probabilities, an eligibility threshold of applicative attributes to be included in the generated application-layer signature.

26. The device of claim 23, wherein attacker probabilities (Pj attacker[n]) are computed as follows:
$${P}_{j} attacker [ n ] = {P}_{j} attack [ n ] \cdot \frac{1 + A F [ n ]}{A F [ n ]} - {P}_{j} baseline \cdot \frac{1}{A F [ n ]}$$
wherein, are derived from computed attack paraphrase distributions, are derived from baseline paraphrase distributions, and is an attack factor.

27. The device of claim 26, wherein the device is further configured to:
sample transactions received during a time window;
for each time window,
build a set of window paraphrase buffers (WPBFs); and
build a set of baseline paraphrase buffers (BPBFs) from transactions directed to the protected entity during peacetime, wherein the BPBFs represent a paraphrase distribution of normal behavior.

28. The device of claim 27, wherein the device is further configured to:
sample transactions received during a time window;
for each time window,
build a set of per-second paraphrase buffers; and
build, from each per-second paraphrase buffers, attack paraphrase distributions from transactions received during an on-going application-layer attack, wherein the attack paraphrase distributions represent paraphrases distributions for a duration of the on-going application-layer attack.

29. The device of claim 28, wherein the device is further configured to:
vector a set of paraphrases derived from the received transactions during a time window; and
buffer the paraphrase vectors to provide the WPBFs and per-second paraphrase buffers.

30. The device of claim 29, wherein the device is further configured to:
update values from the WPBFs into the BPBFs.

31. The device of claim 30, wherein the device is further configured to:
compute paraphrase values mean occurrences for the BPBFs for a current time window based on an average of distributions for paraphrase values in the BPBFs computed for a previous time window, a total of distributions for paraphrase values in the WPBFs for a current time window, and an IIR filter.

32. The device of claim 31, wherein the device is further configured to:
update the distributions from the per-second paraphrase buffer into the attack paraphrase mean histogram; and
update paraphrase value distributions based on transactions directed to the protected entity during an ongoing application-layer attack.

33. The device of claim 32, wherein the device is further configured to:
compute paraphrase values mean distributions for a current time window, over a pre-defined set of per-second distributions for paraphrase values computed for a previous second, a total occurrences for paraphrase values in the pre-defined set of per-second distributions, and an FIR filter, wherein the FIR filter is configured with various weights over the past seconds.

34. The device of claim 25, wherein the device is further configured to:
maintain applicative attributes of transactions, directed to the protected entity, in a paraphrase, wherein each paraphrase includes at least one paraphrase value, wherein a paraphrase value represents an applicative attribute in a transaction.

35. The device of claim 34, wherein the device is further configured to:
set at least one dynamic paraphrase, wherein the dynamic paraphrase includes any one of: an HTTP header key, a cookie key in cookie header, and a query argument key.

36. The device of claim 23, wherein the exclusive section includes a plurality of paraphrase values, wherein the application-layer signature is indicative of an ongoing attack based on all of the plurality of paraphrase values.

37. The device of claim 36, wherein the inclusive section includes a plurality of paraphrase values, wherein the application-layer signature is indicative of an ongoing attack based on at least one of the plurality of paraphrase values.

38. The device of claim 23, wherein the device is further configured to:
determine based, in part, on an attacker probability a set of paraphrase values to be included in the inclusive section.

39. The device of claim 38, wherein the device is further configured to:
select a set of a pre-defined number of paraphrase values with a highest attacker probability and lower than a pre-defined threshold baseline probability to be included in the exclusive section.

40. The device of claim 39, wherein the attacker can be blocked based on at least one applicative attribute included in the exclusive section.

41. The device of claim 23, wherein the ongoing application-layer attack is a DDoS attack realized as an HTTP flood application-layer attack.

42. The device of claim 23, wherein the device is further configured to:
finetune application-layer signatures to reduce a false negative rate, while reducing an estimated egress traffic below a RPS attack threshold and an imposed FP rate below a pre-defined FP rate threshold.
